(19) United States
(12) Patent Application Publication
(10) Pub. No.: US 2025/0184058 A1
(43) Pub. Date: Jun. 5, 2025

(54) MECHANISMS FOR MULTI-CARRIER TRANSMIT SWITCHING FOR NEW RADIO SYSTEMS IN 5G RAN1

(71) Applicant: Intel Corporation, Santa Clara, CA (US)

(72) Inventors: Gang Xiong, Portland, OR (US); Yingyang Li, Beijing (CN); Yi Wang, Beijing (CN)

(73) Assignee: Intel Corporation, Santa Clara, CA (US)

(21) Appl. No.: 18/843,970

(22) PCT Filed: Apr. 26, 2023
(86) PCT No.: PCT/US2023/019976

§ 371 Date: Sep. 4, 2024

Related U.S. Application Data
(60) Provisional application No. 63/336,969, filed on Apr. 29, 2022.
(60) Provisional application No. 63/334,921, filed on Apr. 26, 2022.

(51) Int. Cl. H04L 5/00

(52) U.S. Cl. CPC H04L 5/0044; H04L 5/001; H04L 5/0092

(57) ABSTRACT

An apparatus of a New Radio (NR) Node B (gNB), a method, and a storage medium. The apparatus is to perform operations including: identifying three or more bands for transmit (TX) switching by a user equipment (UE); and encoding for transmission a message to the UE to indicate the three or more bands for TX switching; and storing the three or more bands for TX switching.

### CROSS REFERENCE TO RELATED APPLICATIONS

This application claims the benefit of and priority from U.S. Provisional Patent Application No. 63/334,921 entitled “MECHANISMS ON MULTIPLE CARRIER TRANSMIT (TX) SWITCHING FOR NEW RADIO (NR) SYSTEMS,” filed Apr. 26, 2022, and from U.S. Provisional Patent Application No. 63/336,969 entitled “MECHANISMS ON MULTIPLE CARRIER TRANSMIT (TX) SWITCHING FOR NEW RADIO (NR) SYSTEMS,” filed Apr. 29, 2022.

### FIELD

Various embodiments generally may relate to the field of wireless communications in a cellular network.

### BACKGROUND

Various embodiments generally may relate to the field of wireless communications, and especially to switching transmit (TX) chains on the user equipment (UE) side for uplink shared channel transmissions.

### BRIEF DESCRIPTION OF THE DRAWINGS

FIG. 1 shows a communication network according to some embodiments.

FIG. 2 shows a cellular wireless network between a UE and an access node (AN) according to some embodiments.

FIG. 3 shows components, according to some example embodiments, able to read instructions from a machine-readable or computer-readable medium.

FIG. 4 illustrates a signaling diagram for multi-carrier TX switching according to an example embodiment.

FIG. 5 is a flow chart of a first process according to an embodiment.

FIG. 6 is a flow chart of a second process according to another embodiment.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

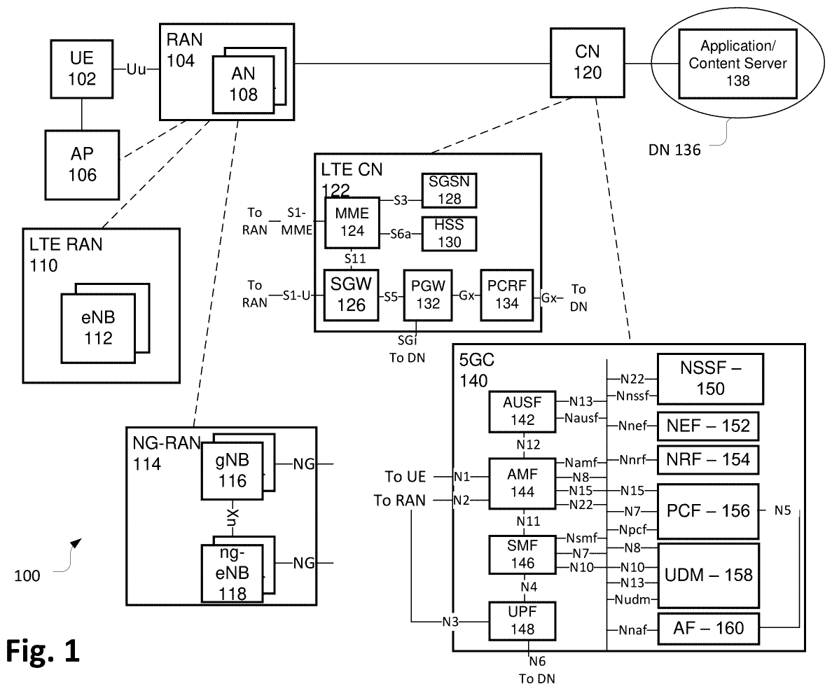

In some embodiments, the electronic device(s), network(s), system(s), chip(s) or component(s), or portions or implementations thereof, of FIGS. 1-3, or some other figure herein, may be configured to perform one or more processes, techniques, or methods as described herein, or portions thereof. One such process is depicted in FIGS. 1-3. In some embodiments, the process may be performed by a New Radio (NR) Node B (gNB) or by a NR User Equipment (UE).

An apparatus of a New Radio (NR) Node B (gNB), a method, and a storage medium. One or more processors of the apparatus are to identify scheduling information for a plurality of cells and related to one or more SCH (SCH) transmissions, the one or more SCH transmissions including one or more physical uplink SCH (PUSCH) transmissions or one or more physical downlink SCH (PDSCH) transmissions; generate a physical downlink control channel (PDCCH) based on the scheduling information; and send the PDCCH for transmission to a user equipment (UE) on a single scheduling cell of the plurality of cells.

### Systems and Implementations

FIGS. 1-3 illustrate various systems, devices, and components that may implement aspects of disclosed embodiments.

FIG. 1 illustrates a network 100 in accordance with various embodiments. The network 100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 100 may include a UE 102, which may include any mobile or non-mobile computing device designed to communicate with a RAN 104 via an over-the-air connection. The UE 102 may be communicatively coupled with the RAN 104 by a Uu interface. The UE 102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102 may additionally communicate with an AP 106 via an over-the-air connection. The AP 106 may manage a WLAN connection, which may serve to offload some/all network traffic from the RAN 104. The connection between the UE 102 and the AP 106 may be consistent with any IEEE 802.11 protocol, wherein the AP 106 could be a wireless fidelity (Wi-Fi®) router. In some embodiments, the UE 102, RAN 104, and AP 106 may utilize cellular-WLAN aggregation (for example, LWA/LWIP). Cellular-WLAN aggregation may involve the UE 102 being configured by the RAN 104 to utilize both cellular radio resources and WLAN resources.

The RAN 104 may include one or more access nodes, for example, AN 108. AN 108 may terminate air-interface protocols for the UE 102 by providing access stratum protocols including RRC, PDCP, RLC, MAC, and L1 protocols. In this manner, the AN 108 may enable data/voice connectivity between CN 120 and the UE 102. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102 with an air interface for network access. The UE 102 may be simultaneously connected with a plurality of cells provided by the same or different ANs of the RAN 104. For example, the UE 102 and RAN 104 may use carrier aggregation to allow the UE 102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 102 or AN 108 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNBs, for example, eNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 104 may be an NG-RAN 114 with gNBs, for example, gNB 116, or ng-eNBs, for example, ng-eNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN 114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operate on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102 can be configured with multiple BWPs where each BWP configuration has a different SCS. When a BWP change is indicated to the UE 102, the SCS of the transmission is changed as well. Another use case example of BWP is related to power saving. In particular, multiple BWPs can be configured for the UE 102 with different amount of frequency resources (for example, PRBs) to support data transmission under different traffic loading scenarios. A BWP containing a smaller number of PRBs can be used for data transmission with small traffic load while allowing power saving at the UE 102 and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows.

The MME 124 may implement mobility management functions to track a current location of the UE 102 to facilitate paging, bearer activation/deactivation, handovers, gateway selection, authentication, etc.

The SGW 126 may terminate an SI interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102 and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an SGi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the SGi reference point between the PGW 132 and the data network 136 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, and AF 160 coupled with one another over interfaces (or “reference points”) as shown. Functions of the elements of the 5GC 140 may be briefly introduced as follows.

The AUSF 142 may store data for authentication of UE 102 and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102 and the RAN 104 and to subscribe to notifications about mobility events with respect to the UE 102. The AMF 144 may be responsible for registration management (for example, for registering UE 102), connection management, reachability management, mobility management, lawful interception of AMF-related events, and access authentication and authorization. The AMF 144 may provide transport for SM messages between the UE 102 and the SMF 146, and act as a transparent proxy for routing SM messages. AMF 144 may also provide transport for SMS messages between UE 102 and an SMSF. AMF 144 may interact with the AUSF 142 and the UE 102 to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling, and perform NAS ciphering and integrity protection. AMF 144 may also support NAS signaling with the UE 102 over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to L1 system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102 and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102. The NSSF 150 may also determine allowed NSSAI and the mapping to the subscribed S-NSSAIs, if needed. The NSSF 150 may also determine the AMF set to be used to serve the UE 102, or a list of candidate AMFs based on a suitable configuration and possibly by querying the NRF 154. The selection of a set of network slice instances for the UE 102 may be triggered by the AMF 144 with which the UE 102 is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 may handle subscription-related information to support the network entities' handling of communication sessions, and may store subscription data of UE 102. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102) for the NEF 152. The Nudr service-based interface may be exhibited by the UDR 221 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3^{rd} party services to be geographically close to a point that the UE 102 is attached to the network. This may reduce latency and load on the network. To provide edge-computing implementations, the 5GC 140 may select a UPF 148 close to the UE 102 and execute traffic steering from the UPF 148 to data network 136 via the N6 interface. This may be based on the UE subscription data, UE location, and information provided by the AF 160. In this way, the AF 160 may influence UPF (re) selection and traffic routing. Based on operator deployment, when AF 160 is considered to be a trusted entity, the network operator may permit AF 160 to interact directly with relevant NFs. Additionally, the AF 160 may exhibit an Naf service-based interface.

The data network 136 may represent various network operator services, Internet access, or third party services that may be provided by one or more servers including, for example, application/content server 138.

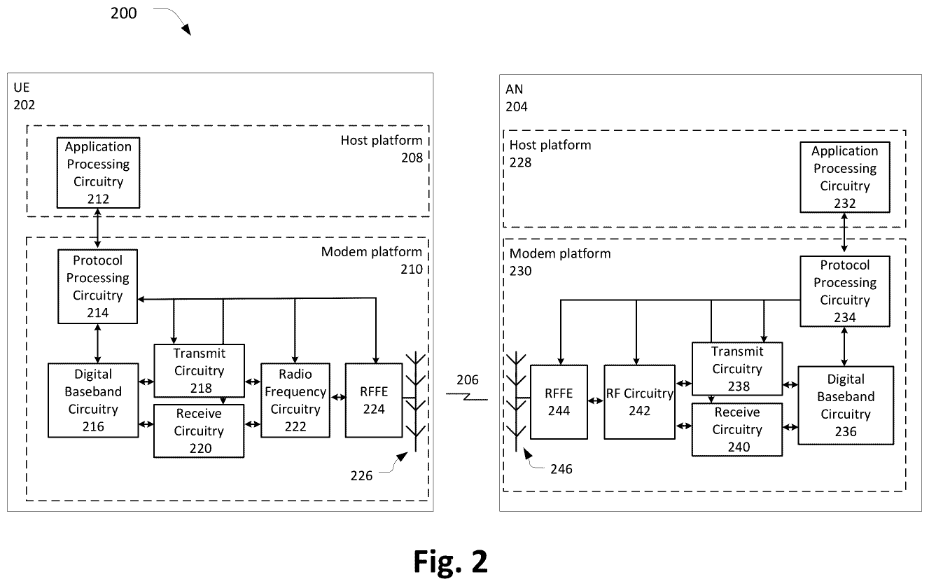

FIG. 2 schematically illustrates a wireless network 200 in accordance with various embodiments. The wireless network 200 may include a UE 202 in wireless communication with an AN 204. The UE 202 and AN 204 may be similar to, and substantially interchangeable with, like-named components described elsewhere herein.

The UE 202 may be communicatively coupled with the AN 204 via connection 206. The connection 206 is illustrated as an air interface to enable communicative coupling, and can be consistent with cellular communications protocols such as an LTE protocol or a 5G NR protocol operating at mmWave or sub-6 GHZ frequencies.

The UE 202 may include a host platform 208 coupled with a modem platform 210. The host platform 208 may include application processing circuitry 212, which may be coupled with protocol processing circuitry 214 of the modem platform 210. The application processing circuitry 212 may run various applications for the UE 202 that source/sink application data. The application processing circuitry 212 may further implement one or more layer operations to transmit/receive application data to/from a data network. These layer operations may include transport (for example UDP) and Internet (for example, IP) operations.

The protocol processing circuitry 214 may implement one or more of layer operations to facilitate transmission or reception of data over the connection 206. The layer operations implemented by the protocol processing circuitry 214 may include, for example, MAC, RLC, PDCP, RRC and NAS operations.

The modem platform 210 may further include digital baseband circuitry 216 that may implement one or more layer operations that are “below” layer operations performed by the protocol processing circuitry 214 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 210 may further include transmit circuitry 218, receive circuitry 220, RF circuitry 222, and RF front end (RFFE) 224, which may include or connect to one or more antenna panels 226. Briefly, the transmit circuitry 218 may include a digital-to-analog converter, mixer, intermediate frequency (IF) components, etc.; the receive circuitry 220 may include an analog-to-digital converter, mixer, IF components, etc.; the RF circuitry 222 may include a low-noise amplifier, a power amplifier, power tracking components, etc.; RFFE 224 may include filters (for example, surface/bulk acoustic wave filters), switches, antenna tuners, beamforming components (for example, phase-array antenna components), etc. The selection and arrangement of the components of the transmit circuitry 218, receive circuitry 220, RF circuitry 222, RFFE 224, and antenna panels 226 (referred generically as “transmit/receive components”) may be specific to details of a specific implementation such as, for example, whether communication is TDM or FDM, in mm Wave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 214 may include one or more instances of control circuitry (not shown) to provide control functions for the transmit/receive components.

A UE reception may be established by and via the antenna panels 226, RFFE 224, RF circuitry 222, receive circuitry 220, digital baseband circuitry 216, and protocol processing circuitry 214. In some embodiments, the antenna panels 226 may receive a transmission from the AN 204 by receive-beamforming signals received by a plurality of antennas/antenna elements of the one or more antenna panels 226.

A UE transmission may be established by and via the protocol processing circuitry 214, digital baseband circuitry 216, transmit circuitry 218, RF circuitry 222, RFFE 224, and antenna panels 226. In some embodiments, the transmit components of the UE 204 may apply a spatial filter to the data to be transmitted to form a transmit beam emitted by the antenna elements of the antenna panels 226.

Similar to the UE 202, the AN 204 may include a host platform 228 coupled with a modem platform 230. The host platform 228 may include application processing circuitry 232 coupled with protocol processing circuitry 234 of the modem platform 230. The modem platform may further include digital baseband circuitry 236, transmit circuitry 238, receive circuitry 240, RF circuitry 242, RFFE circuitry 244, and antenna panels 246. The components of the AN 204 may be similar to and substantially interchangeable with like-named components of the UE 202. In addition to performing data transmission/reception as described above, the components of the AN 208 may perform various logical functions that include, for example, RNC functions such as radio bearer management, uplink and downlink dynamic radio resource management, and data packet scheduling.

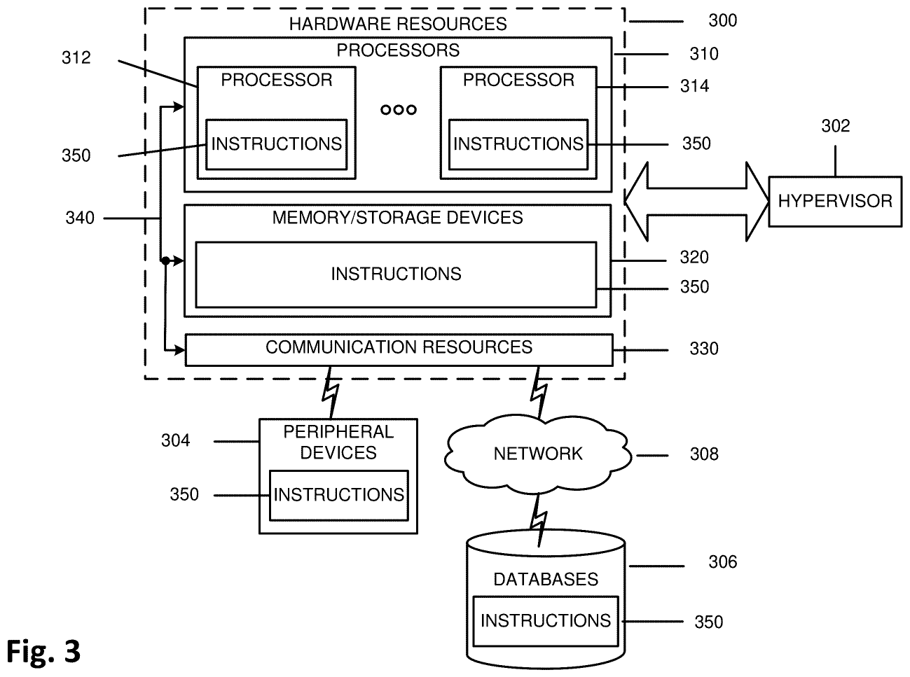

FIG. 3 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 3 shows a diagrammatic representation of hardware resources 300 including one or more processors (or processor cores) 310, one or more memory/storage devices 320, and one or more communication resources 330, each of which may be communicatively coupled via a bus 340 or other interface circuitry. For embodiments where node virtualization (e.g., NFV) is utilized, a hypervisor 302 may be executed to provide an execution environment for one or more network slices/sub-slices to utilize the hardware resources 300.

The processors 310 may include, for example, a processor 312 and a processor 314. The processors 310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 320 may include main memory, disk storage, or any suitable combination thereof. The memory/storage devices 320 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 330 may include interconnection or network interface controllers, components, or other suitable devices to communicate with one or more peripheral devices 304 or one or more databases 306 or other network elements via a network 308. For example, the communication resources 330 may include wired communication components (e.g., for coupling via USB, Ethernet, etc.), cellular communication components, NFC components, Bluetooth® (or Bluetooth® Low Energy) components, Wi-Fi® components, and other communication components.

Instructions 350 may comprise software, a program, an application, an applet, an app, or other executable code for causing at least any of the processors 310 to perform any one or more of the methodologies discussed herein. The instructions 350 may reside, completely or partially, within at least one of the processors 310 (e.g., within the processor's cache memory), the memory/storage devices 320, or any suitable combination thereof. Furthermore, any portion of the instructions 350 may be transferred to the hardware resources 300 from any combination of the peripheral devices 304 or the databases 306. Accordingly, the memory of processors 310, the memory/storage devices 320, the peripheral devices 304, and the databases 306 are examples of computer-readable and machine-readable media.

### Introduction

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich contents and services.

NR supports a wide range of spectrum in different frequency ranges. It is expected that there will be increasing availability of spectrum in the market for 5G Advanced possibly due to re-farming from the bands originally used for previous cellular generation networks. Especially for frequency range (FR1) bands, the available spectrum blocks tend to be more fragmented and scattered with narrower bandwidth. For FR2 bands and some FRI bands, the available spectrum can be wider such that intra-band multi-carrier operation is necessary. To meet different spectrum needs, it is important to ensure that these scattered spectrum bands or wider bandwidth spectrum can be utilized in a more spectral/power efficient and flexible manner, thus providing higher throughput and decent coverage in the network.

In Rel-16, 1Tx-2Tx switching was specified to allow switching between case 1 and case 2 as illustrated in Table 1, for two uplink carriers case inter-band EN-DC without SUL, inter-band UL CA and standalone SUL for UE supporting maximum two concurrent transmission.

TABLE 1
Rel-16 1Tx-2Tx switching

| | Number of Tx chains in WID (carrier 1 + |
|---|---|
| | carrier 2) |
| Case 1 | 1T + 1T |
| Case 2 | 0T + 2T |

Further, in Rel-17, 2Tx-2Tx switching was specified between different cases across carriers based on SUL and NR inter-band uplink CA for UE supporting maximum two concurrent transmissions. In addition, Tx switching was supported in Rel-17 between cases, where 1 carrier on band A and 2 contiguous aggregated carriers on band B, and band A is for SUL or non-SUL and band B is a non-SUL band.

For multi-carrier UL operation, there are certain limitations in current NR system. In particular, 2TX UE can be configured with at most 2 UL bands, which only can be changed by RRC reconfiguration, and UL Tx switching can be only performed between 2 UL bands for 2Tx UE. To improve coverage performance and potentially UE throughput, dynamic Tx switching among 3 or 4 bands can be employed at UE side.

For instance, depending on traffic situations at a UE, gNB may trigger the UE to switch from a band with narrower channel bandwidth to a band with wider channel bandwidth. With such a dynamic Tx switching and resource assignment, a higher UE throughput may be expected. To support multi-carrier Tx switching, certain mechanisms including mapping between UL transmission ports and Tx chain and switching mechanism may need to be considered.

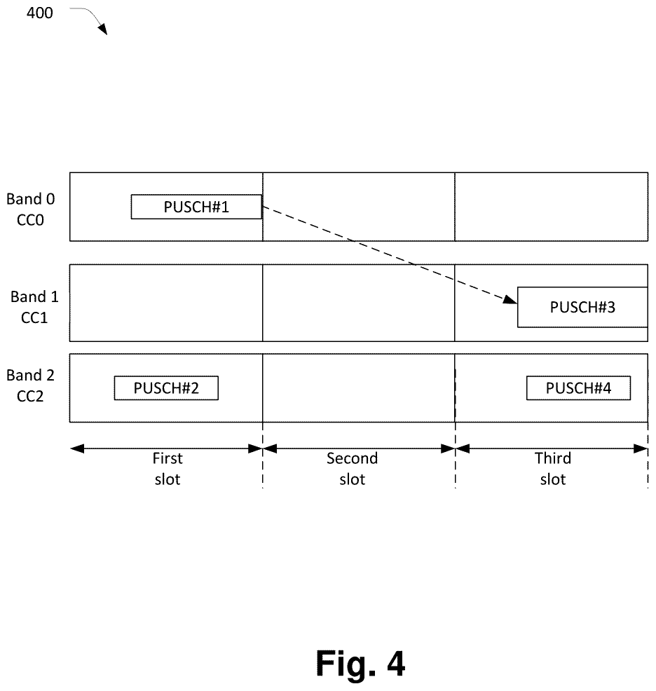

FIG. 4 illustrates one example of multi-carrier dynamic Tx switching. In the example, Tx switching is performed across 3 bands. In FIG. 4, band 0 with component carrier (CC) 0 is used by a UE to transmit a PUSCH #1 in a first slot. In the first slot, band 2 with CC2 is used by the UE to transmit PUSCH #2 in the same first slot. The next slot for all of bands 0-2 and CCs 1-2 are empty. Thereafter, the signaling diagram shows the UE as having switched its TX chain from band 0 CC0 to band 1 CC1 for transmission of PUSCH #3 in a third slot, with a scheduling gap that encompasses the second slot existing between PUSCH #1 and PUSCH #3. Moreover, the UE transmits in the same third slot a PUSCH #4 on band 2 CC2, meaning that there was not TX chain switching by the UE with respect to transmitting in band 2 CC2. In addition, UE is triggered to transmit a next PUSCH in a band with wider channel bandwidth.

Embodiments herein relate to mechanisms on multiple carrier Tx switching for NR systems. In particular, embodiments may relate to one or more of the following:
Mapping between UL transmission ports and Tx chain for multiple carrier Tx switching
Switching mechanism for multiple carrier Tx switching
Switching location for multiple carrier Tx switching

### Mapping Between UL Transmission Ports and Tx Chain for Multiple Carrier Tx Switching

As mentioned above, for multi-carrier UL operation, there are certain limitations in current NR system. In particular, 2TX UE can be configured with at most 2 UL bands, which only can be changed by RRC reconfiguration, and UL Tx switching can be only performed between 2 UL bands for 2Tx UE. To improve coverage performance and potentially UE throughput, dynamic Tx switching among 3 or 4 bands can be employed at UE side.

For instance, depending on traffic situations at a UE, gNB may trigger the UE to switch from a band with narrower channel bandwidth to a band with wider channel bandwidth. With such a dynamic Tx switching and resource assignment, a higher UE throughput may be expected. To support multi-carrier Tx switching, certain mechanisms including mapping between UL transmission ports and Tx chain and switching mechanism may need to be considered.

Embodiments of mapping between UL transmission ports and Tx chain for multiple carrier Tx switching are provided as follows:

In one embodiment, the mapping between UL transmission ports and Tx chain for multi-carrier Tx switching is defined in accordance with the band and/or carrier index, which is activated and configured for Tx switching.

In one embodiment, for carrier aggregation (CA) option 1, where if uplink Tx switching is configured, UE is not expected to be scheduled or configured with UL transmission on both bands (carriers), when UE performs Tx switching across 3 bands, i.e., Band A, B and C, respectively, the mapping between UL transmission ports and Tx chain for CA option 1 across 3 bands can be defined in Table 2:

TABLE 2
Multi-carrier Tx switching across 3
bands for CA option 1: Alternative 1

| | Number of Tx chains in | Number of antenna ports for |
|---|---|---|
| | WID (band A + band B + | UL transmission (band A + |
| | band C) | band B + band C) |
| Case 1-1 | 1T + 1T (band A + band B) | 1P + 0P |
| Case 1-2 | 1T + 1T (band A + band C) | 1P + 0P |
| Case 1-3 | 1T + 1T (band B + band C) | 1P + 0P |
| Case 2-1 | 0T + 2T (band A/C + band B) | 0P + 2P, 0P + 1P |
| Case 2-2 | 0T + 2T (band A/B + band C) | 0P + 2P, 0P + 1P |
| Case 2-3 | 0T + 2T (band B/C + band A) | 0P + 2P, 0P + 1P |

In another option, for CA option 1, the mapping between UL transmission ports and Tx chain for CA option 1 across 3 bands can be defined in Table 3.

TABLE 3
Multi-carrier Tx switching across 3
bands for CA option 1: Alternative 2

| | Number of Tx chains in | Number of antenna ports for |
|---|---|---|
| | WID (band A + band B + | UL transmission (band A + |
| | band C) | band B + band C) |
| Case 1-1 | 1T + 1T (band A + band B/C) | 1P + 0P |
| Case 1-2 | 1T + 1T (band B + band C/A) | 1P + 0P |
| Case 1-3 | 1T + 1T (band C + band A/B) | 1P + 0P |
| Case 2-1 | 0T + 2T (band A/C + band B) | 0P + 2P, 0P + 1P |
| Case 2-2 | 0T + 2T (band A/B + band C) | 0P + 2P, 0P + 1P |
| Case 2-3 | 0T + 2T (band B/C + band A) | 0P + 2P, 0P + 1P |

Note that the above options are based on the assumption that all bands support 2Tx. In the event that one of the bands only supports 1Tx, a subset of the above tables can be used for the mapping between UL transmission ports and Tx chain for CA option 1 across 3 bands, as illustrated in Table 4. In the table, it is assumed that band B and C support 2Tx while band A supports 1Tx. Note that the examples listed below can be straightforwardly extended to the case when different bands support 1Tx or 2Tx, respectively.

TABLE 4
Multi-carrier Tx switching across 3
bands for CA option 1: Alternative 3

| | Number of Tx chains in | Number of antenna ports for |
|---|---|---|
| | WID (band A + band B + | UL transmission (band A + |
| | band C) | band B + band C) |
| Case 1-1 | 1T + 1T (band A + band B/C) | 1P + 0P |
| Case 1-2 | 1T + 1T (band B + band C/A) | 1P + 0P |
| Case 1-3 | 1T + 1T (band C + band A/B) | 1P + 0P |
| Case 2-1 | 0T + 2T (band A/C + band B) | 0P + 2P, 0P + 1P |
| Case 2-2 | 0T + 2T (band A/B + band C) | 0P + 2P, 0P + 1P |

In another option, for CA option 1, the mapping between UL transmission ports and Tx chain across 3 bands can be defined in Table 5:

TABLE 5
Multi-carrier Tx switching across 3
bands for CA option 1: Alternative 4

| | Number of Tx chains in | Number of antenna ports for |
|---|---|---|
| | WID (band A + band | UL transmission (band A + |
| | B + band C) | band B + band C) |
| Case 1-1 | 1T + 1T + 0T | 1P + 0P + 0P |
| Case 1-2 | 1T + 0T + 1T | 1P + 0P + 0P |
| Case 1-3 | 0T + 1T + 1T | 0P + 1P + 0P |
| Case 2-1 | 0T + 2T + 0T | 0P + 2P + 0P, 0P + 1P + 0P |
| Case 2-2 | 0T + 0T + 2T | 0P + 0P + 2P, 0P + 0P + 1P |
| Case 2-3 | 2T + 0T + 0T | 2P + 0P + 0P, 1P + 0P + 0P |

In another embodiment, for CA option 2, where if uplink Tx switching is configured, UE can be scheduled or configured with UL transmission on both bands (carriers) simultaneously, when UE performs Tx switching across 3 bands, i.e., Band A, B and C, respectively, the mapping between UL transmission ports and Tx chain across 3 bands can be defined in Table 6.

TABLE 6
Multi-carrier Tx switching across 3
bands for CA option 2: Alternative 1

| | Number of Tx chains in | Number of antenna ports for |
|---|---|---|
| | WID (band A + band | UL transmission (band A + |
| | B + band C) | band B + band C) |
| Case 1-1 | 1T + 1T (band A + band B) | 1P + 0P, 1P + 1P, 0P + 1P |
| Case 1-2 | 1T + 1T (band A + band C) | 1P + 0P, 1P + 1P, 0P + 1P |
| Case 1-3 | 1T + 1T (band B + band C) | 1P + 0P, 1P + 1P, 0P + 1P |
| Case 2-1 | 0T + 2T (band A/C + band B) | 0P + 2P, 0P + 1P |
| Case 2-2 | 0T + 2T (band A/B + band C) | 0P + 2P, 0P + 1P |
| Case 2-3 | 0T + 2T (band B/C + band A) | 0P + 2P, 0P + 1P |

Note that the supported mapping between UL transmission ports and Tx chain in Table 6 may be further limited by additional rules. For example, if it is ‘1T+1T’ for a pair of bands that respectively include a SUL carrier and a UL carrier of the same cell, only ‘1P+0P’ or ‘0P+1P’ is applicable. Alternatively, if it is ‘1T+1T’ for a pair of bands that respectively include a SUL carrier and a UL carrier of the same cell, only ‘1P+0P’ is applicable, and the carrier for the ‘1P’ is determined according to a pre-defined rule, e.g., the carrier is SUL carrier, or the carrier is configured by gNB. Table 6A provides an example. Assuming band A and band B respectively include a SUL carrier and a UL carrier of the same cell, the applicable number of antenna ports in Table 6 is provided in Table 6A.

TABLE 6A
Multi-carrier Tx switching across 3
bands for CA option 2: Alternative 1A

| | Number of Tx chains in | Number of antenna ports for |
|---|---|---|
| | WID (band A + band | UL transmission (band A + |
| | B + band C) | band B + band C) |
| Case 1-1 | 1T + 1T (band A + band B) | 1P + 0P |
| Case 1-2 | 1T + 1T (band A + band C) | 1P + 0P, 1P + 1P, 0P + 1P |
| Case 1-3 | 1T + 1T (band B + band C) | 1P + 0P, 1P + 1P, 0P + 1P |
| Case 2-1 | 0T + 2T (band A/C + band B) | 0P + 2P, 0P + 1P |
| Case 2-2 | 0T + 2T (band A/B + band C) | 0P + 2P, 0P + 1P |
| Case 2-3 | 0T + 2T (band B/C + band A) | 0P + 2P, 0P + 1P |

Note that the above options are based on the assumption that all bands support 2Tx. In the event that one of the bands only supports 1Tx, a subset of the above tables can be used for the mapping between UL transmission ports and Tx chain for CA option 2 across 3 bands, as illustrated in Table 7. In the table, it is assumed that band B and C support 2Tx while band A supports 1Tx. Note that the examples listed below can be straightforwardly extended to the case when different bands support 1Tx or 2Tx, respectively.

TABLE 7
Multi-carrier Tx switching across 3
bands for CA option 2: Alternative 2

| | Number of Tx chains in | Number of antenna ports for |
|---|---|---|
| | WID (band A + band | UL transmission (band A + |
| | B + band C) | band B + band C) |
| Case 1-1 | 1T + 1T (band A + band B) | 1P + 0P, 1P + 1P, 0P + 1P |
| Case 1-2 | 1T + 1T (band B + band C) | 1P + 0P, 1P + 1P, 0P + 1P |
| Case 1-3 | 1T + 1T (band C + band A) | 1P + 0P, 1P + 1P, 0P + 1P |
| Case 2-1 | 0T + 2T (band A/C + band B) | 0P + 2P, 0P + 1P |
| Case 2-2 | 0T + 2T (band A/B + band C) | 0P + 2P, 0P + 1P |

In another option, for CA option 2, the mapping between UL transmission ports and Tx chain 1 across 3 bands can be defined in Table 8.

TABLE 8
Multi-carrier Tx switching across 3
bands for CA option 2: Alternative 3

| | Number of Tx chains in | Number of antenna ports for |
|---|---|---|
| | WID (band A + band | UL transmission (band A + band |
| | B + band C) | B + band C) |
| Case 1-1 | 1T + 1T + 0T | 1P + 0P + 0P, 1P + 1P + 0P, |
| | | 0P + 1P + 0P |
| Case 1-2 | 1T + 0T + 1T | 1P + 0P + 0P, 1P + 0P + 1P, |
| | | 0P + 0P + 1P |
| Case 1-3 | 0T + 1T + 1T | 0P + 1P + 0P, 0P + 1P + 1P, |
| | | 0P + 0P + 1P |
| Case 2-1 | 0T + 2T + 0T | 0P + 2P + 0P, 0P + 1P + 0P |
| Case 2-2 | 0T + 0T + 2T | 0P + 0P + 2P, 0P + 0P + 1P |
| Case 2-3 | 2T + 0T + 0T | 2P + 0P + 0P, 1P + 0P + 0P |

Similar to CA option 1, for CA option 2, In the event that one of the bands supports 1Tx, a subset of the above tables can be used for the mapping between UL transmission ports and Tx chain for CA option 1 across 3 bands.

In one embodiment, for CA option 1, where if uplink Tx switching is configured, UE is not expected to be scheduled or configured with UL transmission on both bands (carriers), when UE performs Tx switching across 4 bands, i.e., Band A, B, C and D, respectively, the mapping between UL transmission ports and Tx chain for CA option 1 across 4 bands can be defined in Table 9:

TABLE 9
Multi-carrier Tx switching across 4
bands for CA option 1: Alternative 1

| | Number of Tx chains in | Number of antenna ports for |
|---|---|---|
| | WID (band A + band | UL transmission (band A + |
| | B + band C + band D) | band B + band C + band D) |
| Case 1-1 | 1T + 1T (band A + band B) | 1P + 0P |
| Case 1-2 | 1T + 1T (band A + band C) | 1P + 0P |
| Case 1-3 | 1T + 1T (band A + band D) | 1P + 0P |
| Case 1-4 | 1T + 1T (band B + band C) | 1P + 0P |
| Case 1-5 | 1T + 1T (band B + band D) | 1P + 0P |
| Case 1-6 | 1T + 1T (band C + band D) | 1P + 0P |
| Case 2-1 | 0T + 2T (band A/B/C + | 0P + 2P, 0P + 1P |
| | band D) | |
| Case 2-2 | 0T + 2T (band A/B/D + | 0P + 2P, 0P + 1P |
| | band C) | |
| Case 2-3 | 0T + 2T (band A/C/D + | 0P + 2P, 0P + 1P |
| | band B) | |
| Case 2-1 | 0T + 2T (band B/C/D + | 0P + 2P, 0P + 1P |
| | band A) | |

In another option, the mapping between UL transmission ports and Tx chain for CA option 1 across 4 bands can be defined in Table 10.

TABLE 10
Multi-carrier Tx switching across 4
bands for CA option 1: Alternative 2

| | Number of Tx chains in | Number of antenna ports for |
|---|---|---|
| | WID (band A + band | UL transmission (band A + |
| | B + band C + band D) | band B + band C + band D) |
| Case 1-1 | 1T + 1T (band A + | 1P + 0P |
| | band B/C/D) | |
| Case 1-2 | 1T + 1T (band B + | 1P + 0P |
| | band A/C/D) | |
| Case 1-3 | 1T + 1T (band C + | 1P + 0P |
| | band A/B/D) | |
| Case 1-4 | 1T + 1T (band D + | 1P + 0P |
| | band A/B/C) | |
| Case 2-1 | 0T + 2T (band A/B/C + | 0P + 2P, 0P + 1P |
| | band D) | |
| Case 2-2 | 0T + 2T (band A/B/D + | 0P + 2P, 0P + 1P |
| | band C) | |
| Case 2-3 | 0T + 2T (band A/C/D + | 0P + 2P, 0P + 1P |
| | band B) | |
| Case 2-1 | 0T + 2T (band B/C/D + | 0P + 2P, 0P + 1P |
| | band A) | |

In another option, for CA option 1, the mapping between UL transmission ports and Tx chain across 4 bands can be defined in Table 11:

TABLE 11
Multi-carrier Tx switching across 4
bands for CA option 1: Alternative 3

| | Number of Tx chains in | Number of antenna ports for |
|---|---|---|
| | WID (band A + band | UL transmission (band A + |
| | B + band C + band D) | band B + band C + band D) |
| Case 1-1 | 1T + 1T + 0T + 0T | 1P + 0P + 0P + 0P |
| Case 1-2 | 1T + 0T + 1T + 0T | 1P + 0P + 0P + 0P |
| Case 1-3 | 1T + 0T + 0T + 1T | 1P + 0P + 0P + 0P |
| Case 1-4 | 0T + 1T + 1T + 0T | 0P + 1P + 0P + 0P |
| Case 1-5 | 0T + 1T + 0T + 1T | 0P + 1P + 0P + 0P |
| Case 1-6 | 0T + 0T + 1T + 1T | 0P + 0P + 1P + 0P |
| Case 2-1 | 0T + 0T + 0T + 2T | 0P + 0P + 0P + 2P, |
| | | 0P + 0P + 0P + 1P |
| Case 2-2 | 0T + 0T + 2T + 0T | 0P + 0P + 2P + 0P, |
| | | 0P + 0P + 1P + 0P |
| Case 2-3 | 0T + 2T + 0T + 0T | 0P + 2P + 0P + 0P, |
| | | 0P + 1P + 0P + 0P |
| Case 2-4 | 2T + 0T + 0T + 0T | 2P + 0P + 0P + 0P, |
| | | 1P + 0P + 0P + 0P |

Similar to the mapping between UL transmission ports and Tx chain across 3 bands, when one of the bands supports 1Tx, a subset of the above tables can be used for the mapping between UL transmission ports and Tx chain across 4 bands.

In another embodiment, for CA option 2, where if uplink Tx switching is configured, UE can be scheduled or configured with UL transmission on both bands (carriers) simultaneously, when UE performs Tx switching across 4 bands, i.e., Band A, B, C and D, respectively, the mapping between UL transmission ports and Tx chain across 4 bands can be defined in Table 12.

TABLE 12
Multi-carrier Tx switching across 4
bands for CA option 2: Alternative 1

| | Number of Tx chains in | Number of antenna ports for |
|---|---|---|
| | WID (band A + band | UL transmission (band A + |
| | B + band C + band D) | band B + band C + band D) |
| Case 1-1 | 1T + 1T (band A + band B) | 1P + 0P, 1P + 1P, 0P + 1P |
| Case 1-2 | 1T + 1T (band A + band C) | 1P + 0P, 1P + 1P, 0P + 1P |
| Case 1-3 | 1T + 1T (band A + band D) | 1P + 0P, 1P + 1P, 0P + 1P |
| Case 1-4 | 1T + 1T (band B + band C) | 1P + 0P, 1P + 1P, 0P + 1P |
| Case 1-5 | 1T + 1T (band B + band D) | 1P + 0P, 1P + 1P, 0P + 1P |
| Case 1-6 | 1T + 1T (band C + band D) | 1P + 0P, 1P + 1P, 0P + 1P |
| Case 2-1 | 0T + 2T (band A/B/C + | 0P + 2P, 0P + 1P |
| | band D) | |
| Case 2-2 | 0T + 2T (band A/B/D + | 0P + 2P, 0P + 1P |
| | band C) | |
| Case 2-3 | 0T + 2T (band A/C/D + | 0P + 2P, 0P + 1P |
| | band B) | |
| Case 2-4 | 0T + 2T (band B/C/D + | 0P + 2P, 0P + 1P |
| | band A) | |

In another option, for CA option 2, the mapping between UL transmission ports and Tx chain 1 across 4 bands can be defined in Table 13:

TABLE 13
Multi-carrier Tx switching across 4
bands for CA option 2: Alternative 2

| | Number of Tx chains in | Number of antenna ports for UL |
|---|---|---|
| | WID (band A + band | transmission (band A + band |
| | B + band C + band D) | B + band C + band D) |
| Case 1-1 | 1T + 1T + 0T + 0T | 1P + 0P + 0P + 0P, 1P + |
| | | 1P + 0P + 0P, 0P + 1P + |
| | | 0P + 0P |
| Case 1-2 | 1T + 0T + 1T + 0T | 1P + 0P + 0P + 0P, 1P + |
| | | 0P + 1P + 0P, 0P + 0P + |
| | | 1P + 0P |
| Case 1-3 | 1T + 0T + 0T + 1T | 1P + 0P + 0P + 0P, 1P + |
| | | 0P + 0P + 1P, 0P + 0P + |
| | | 0P + 1P |
| Case 1-4 | 0T + 1T + 1T + 0T | 0P + 1P + 0P + 0P, 0P + |
| | | 1P + 1P + 0P, 0P + 0P + |
| | | 1P + 0P |
| Case 1-5 | 0T + 1T + 0T + 1T | 0P + 1P + 0P + 0P, 0P + |
| | | 1P + 0P + 1P, 0P + 0P + |
| | | 0P + 1P |
| Case 1-6 | 0T + 0T + 1T + 1T | 0P + 0P + 1P + 0P, 0P + |
| | | 0P + 1P + 1P, 0P + 0P + |
| | | 0P + 1P |
| Case 2-1 | 0T + 0T + 0T + 2T | 0P + 0P + 0P + 2P, 0P + |
| | | 0P + 0P + 1P |
| Case 2-2 | 0T + 0T + 2T + 0T | 0P + 0P + 2P + 0P, 0P + |
| | | 0P + 1P + 0P |
| Case 2-3 | 0T + 2T + 0T + 0T | 0P + 2P + 0P + 0P, 0P + |
| | | 1P + 0P + 0P |
| Case 2-4 | 2T + 0T + 0T + 0T | 2P + 0P + 0P + 0P, 1P + |
| | | 0P + 0P + 0P |

Similar to the mapping between UL transmission ports and Tx chain across 3 bands, when one of the bands supports 1Tx, a subset of the above tables can be used for the mapping between UL transmission ports and Tx chain across 4 bands.

Note that the above embodiments including CA option 1 and CA option 2 can also be applied for Supplementary Uplink (SUL) operation. In another option, the above embodiments for CA option 1 can be applied for SUL operation.

When the UL carriers for a UE are configured on N bands, e.g., N=3 or 4, different carrier aggregation (CA) options may be applicable for different pairs of bands. Particularly, one use case of such operation is that SUL carrier(s) are configured on one or more of the N bands.

In one embodiment, for the switching between a band configured with a SUL carrier of a cell and another band configured with UL carrier of the same cell, only the carrier aggregation (CA) option 1 can be used. On the other hand, for other pairs of bands, both carrier aggregation (CA) option 1 and carrier aggregation (CA) option 2 can be applicable.

In one option, when UE performs Tx switching across 3 bands, i.e., band A, B and C, respectively, the following configuration may be supported: a SUL carrier is configured on band A, a UL carrier associated with the SUL carrier is configured on band B, and another UL carrier of a different cell is configured on band C. The mapping between UL transmission ports and Tx chain across 3 bands can be defined in Table 14.

TABLE 14
Multi-carrier Tx switching across 3 bands
for mixed CA option 1 & 2: Alternative 1

| | Number of Tx chains in | Number of antenna ports for |
|---|---|---|
| | WID (band A + band | UL transmission (band A + |
| | B + band C) | band B + band C) |
| Case 1-1 | 1T + 1T (band A + band B) | 1P + 0P (Option 1) |
| Case 1-2 | 1T + 1T (band A + band C) | 1P + 0P, 1P + 1P, |
| | | 0P + 1P (Option 2) |
| Case 1-3 | 1T + 1T (band B + band C) | 1P + 0P, 1P + 1P, |
| | | 0P + 1P (Option 2) |
| Case 2-1 | 0T + 2T (band A/C + band B) | 0P + 2P, 0P + 1P |
| Case 2-2 | 0T + 2T (band A/B + band C) | 0P + 2P, 0P + 1P |
| Case 2-3 | 0T + 2T (band B/C + band A) | 0P + 2P, 0P + 1P |

Note that the above options are based on the assumption that all bands support 2Tx. In the event that one of the bands only supports 1Tx, a subset of the above tables can be used for the mapping between UL transmission ports and Tx chain across 3 bands, as illustrated in Table 15. In the table, it is assumed that band B and C support 2Tx while band A only supports 1Tx. Note that the examples listed below can be straightforwardly extended to the case when different bands support 1Tx or 2Tx, respectively.

TABLE 15
Multi-carrier Tx switching across 3 bands
for mixed CA option 1 & 2: Alternative 2

| | Number of Tx chains in | Number of antenna ports for |
|---|---|---|
| | WID (band A + band | UL transmission (band A + |
| | B + band C) | band B + band C) |
| Case 1-1 | 1T + 1T (band A + band B) | 1P + 0P (Option 1) |
| Case 1-2 | 1T + 1T (band B + band C) | 1P + 0P, 1P + 1P, |
| | | 0P + 1P (Option 2) |
| Case 1-3 | 1T + 1T (band C + band A) | 1P + 0P, 1P + 1P, |
| | | 0P + 1P (Option 2) |
| Case 2-1 | 0T + 2T (band A/C + band B) | 0P + 2P, 0P + 1P |
| Case 2-2 | 0T + 2T (band A/B + band C) | 0P + 2P, 0P + 1P |

In another embodiment, for the switching between a band configured with SUL carrier of a cell and another band configured with a UL carrier of the same or different cell, only the carrier aggregation (CA) option 1 can be used. On the other hand, for other pairs of bands, both carrier aggregation (CA) option 1 and carrier aggregation (CA) option 2 can be applicable.

In one option, when UE performs Tx switching across 3 bands, i.e., Band A, B and C, respectively, the following configuration may be supported: a SUL carrier is configured on band A, a UL carrier associated with the SUL carrier is configured on band B, and another UL carrier of a different cell is configured on band C. The mapping between UL transmission ports and Tx chain across 3 bands can be defined in Table 16.

TABLE 16
Multi-carrier Tx switching across 3 bands
for mixed CA option 1 & 2: Alternative 1

| | Number of Tx chains in | Number of antenna ports for |
|---|---|---|
| | WID (band A + band | UL transmission (band A + |
| | B + band C) | band B + band C) |
| Case 1-1 | 1T + 1T (band A + band B) | 1P + 0P (Option 1) |
| Case 1-2 | 1T + 1T (band A + band C) | 1P + 0P (Option 1) |
| Case 1-3 | 1T + 1T (band B + band C) | 1P + 0P, 1P + 1P, |
| | | 0P + 1P (Option 2) |
| Case 2-1 | 0T + 2T (band A/C + band B) | 0P + 2P, 0P + 1P |
| Case 2-2 | 0T + 2T (band A/B + band C) | 0P + 2P, 0P + 1P |
| Case 2-3 | 0T + 2T (band B/C + band A) | 0P + 2P, 0P + 1P |

Note that the above options are based on the assumption that all bands support 2Tx. In the event that one of the bands only supports 1Tx, a subset of the above tables can be used for the mapping between UL transmission ports and Tx chain for CA option 2 across 3 bands, as illustrated in Table 17. In the table, it is assumed that band B and C support 2Tx while band A only supports 1Tx. Note that the examples listed below can be straightforwardly extended to the case when different bands support 1Tx or 2Tx, respectively.

TABLE 17
Multi-carrier Tx switching across 3 bands
for mixed CA option 1 & 2: Alternative 2

| | Number of Tx chains in | Number of antenna ports for |
|---|---|---|
| | WID (band A + band | UL transmission (band A + |
| | B + band C) | band B + band C) |
| Case 1-1 | 1T + 1T (band A + band B) | 1P + 0P (Option 1) |
| Case 1-2 | 1T + 1T (band A + band C) | 1P + 0P (Option 1) |
| Case 1-3 | 1T + 1T (band B + band C) | 1P + 0P, 1P + 1P, |
| | | 0P + 1P (Option 2) |
| Case 2-1 | 0T + 2T (band A/C + band B) | 0P + 2P, 0P + 1P |
| Case 2-2 | 0T + 2T (band A/B + band C) | 0P + 2P, 0P + 1P |

In one embodiment, the carrier aggregation (CA) option 1 or 2 for Tx switching can be separately configured for each pair of bands. For example, for Tx switching across 4 bands, i.e., Band A, B, C and D, respectively, it may be configured only carrier aggregation (CA) option 1 can be used for ‘band A+band B’ and ‘band C+band D’, and both carrier aggregation (CA) option 1 and 2 are applicable to other pairs of bands. The mapping between UL transmission ports and Tx chain across 4 bands can be defined in Table 18.

TABLE 18
Multi-carrier Tx switching across 4 bands
mixed CA option on 1 & 2: Alternative 1

| | Number of Tx chains in | Number of antenna ports for |
|---|---|---|
| | WID (band A + band | UL transmission (band A + |
| | B + band C + band D) | band B + band C + band D) |
| Case 1-1 | 1T + 1T (band A + band B) | 1P + 0P (Option 1) |
| Case 1-2 | 1T + 1T (band A + band C) | 1P + 0P, 1P + 1P, |
| | | 0P + 1P (Option 2) |
| Case 1-3 | 1T + 1T (band A + band D) | 1P + 0P, 1P + 1P, |
| | | 0P + 1P (Option 2) |
| Case 1-4 | 1T + 1T (band B + band C) | 1P + 0P, 1P + 1P, |
| | | 0P + 1P (Option 2) |
| Case 1-5 | 1T + 1T (band B + band D) | 1P + 0P, 1P + 1P, |
| | | 0P + 1P (Option 2) |
| Case 1-6 | 1T + 1T (band C + band D) | 1P + 0P (Option 1) |
| Case 2-1 | 0T + 2T (band A/B/C + | 0P + 2P, 0P + 1P |
| | band D) | |
| Case 2-2 | 0T + 2T (band A/B/D + | 0P + 2P, 0P + 1P |
| | band C) | |
| Case 2-3 | 0T + 2T (band A/C/D + | 0P + 2P, 0P + 1P |
| | band B) | |
| Case 2-4 | 0T + 2T (band B/C/D + | 0P + 2P, 0P + 1P |
| | band A) | |

### Switching Mechanism for Multiple Carrier Tx Switching

Embodiments of switching mechanism for multiple carrier Tx switching are provided as follows:

In one embodiment, for uplink CA option 2 of mapping between UL transmission ports and Tx chain, the Tx switching delay is applicable for the following case:
If the current state of Tx chains is 1Tx on a first carrier in a first band and 1Tx on a second carrier in a second band, the next UL transmission has a 2-port transmission on either the first carrier in the first band or the second carrier in the second band.
If the current state of Tx chains is 1Tx on a first carrier in a first band and 1Tx on a second carrier in a second band, the next UL transmission has a 2-port transmission on a third carrier in a third band;
If the current state of Tx chains is 1Tx on a first carrier in a first band and 1Tx on a second carrier in a second band, the next UL transmission has a 1-port transmission on the first carrier in the first band and 1-port transmission on a third carrier in a third carrier.
If the current state of Tx chains is 1Tx on a first carrier in a first band and 1Tx on a second carrier in a second band, the next UL transmission has a 1-port transmission on the second carrier in the second band and 1-port transmission on a third carrier in a third carrier.
If the current state of Tx chains is 1Tx on a first carrier in a first band and 1Tx on a second carrier in a second band, the next UL transmission has 1-port transmission on a third carrier in a third carrier.
If the current state of Tx chains is 0Tx on a first carrier in a first band and 2Tx on a second carrier in a second band, the next UL transmission has a 1-port or 2-port transmission on the first carrier in the first band;
If the current state of Tx chains is 2Tx on a first carrier in a first band and 0Tx on a second carrier in a second band, the next UL transmission has a 1-port or 2-port transmission on the second carrier in the second band.

Note that in the above cases, more than one carrier may be configured or indicated or triggered in a band for Tx switching.

In another option, for multi-carrier Tx switching, the Tx switching delay is applicable for the switching between different cases as defined in the aforementioned tables for the mapping between UL transmission ports and Tx chain.

Further, the Tx switching delay for multi-carrier Tx switching across 3 or 4 bands may be separately configured by higher layers, which may also depend on UE capability. Similarly, this may also extend to the case when one or more bands support only 1 Tx. In this case, the Tx switching delay for multi-carrier Tx switching across 3 or 4 bands may be separately configured In the event that one or more bands support 1Tx and/or 2Tx, respectively.

In another embodiment, for CA Option 2, if UL Tx switching is triggered for 1-port transmission on a first carrier in a first band and the state of Tx chains after the UL Tx switching is not unique, for example, when the UE is under the operation state in which 2-port transmission can be supported on one carrier on one band followed by no transmission on any carrier on the same band and 1-port transmission on the other carrier on another band, a parameter can be configured by dedicated radio resource control (RRC) signaling or dynamically indicated in the downlink control information (DCI) or a combination thereof to configure or indicate the state of Tx chains and band information. For example, the RRC signaling can configure between at least two or more of the following:
The state of Tx chains supporting 2Tx transmission on the first carrier in the first band is assumed.
1Tx on the first carrier in the first band and 1Tx on a second carrier in a second band is assumed.
1Tx on the first carrier in the first band and 1Tx on a third carrier in a third band is assumed.
1Tx on the first carrier in the first band and 1Tx on a fourth carrier in a fourth band is assumed.

In another option, for CA Option 2, if UL Tx switching is triggered for 1-port transmission on a first carrier in a first band and the state of Tx chains after the UL Tx switching is not unique, for example, when the UE is under the operation state in which 2-port transmission can be supported on one carrier on one band followed by no transmission on any carrier on the same band and 1-port transmission on the other carrier on another band, a parameter can be configured by dedicated RRC signaling or dynamically indicated by DCI to configure between the following:
The state of Tx chains supporting 2Tx transmission on the first carrier in the first band is assumed.
1Tx on the first carrier in the first band and 1Tx on a second carrier in a second band is assumed.

The second band is one of bands configured or activated for Tx switching, and the second band can be configured by higher layers or implicitly determined according to a pre-defined rule. For example, the second band is the next band with smallest or largest band index, or the second band is the band used for last transmission, or the band next to the first band (either with a larger index or smaller index). The second band could be the band that the UE is used immediately before the UL Tx switching for 1-port transmission on the first carrier in the first band.

In another option, for CA Option 2, if UL Tx switching is triggered for 1-port transmission on a first carrier in a first band and the state of Tx chains after the UL Tx switching is not unique, for example, when the UE is under the operation state in which 2-port transmission can be supported on one carrier on one band followed by no transmission on any carrier on the same band and 1-port transmission on the other carrier on another band, a parameter can be configured by dedicated RRC signaling to configure between the following:
The state of Tx chains supporting 2Tx transmission on the first carrier in the first band is assumed.
1Tx on the first carrier in the first band and 1Tx on a second carrier in a second band is assumed.

Further, additional parameter may be configured by RRC signaling to configure between the following:
1Tx on the first carrier in the first band and 1Tx on a second carrier in a second band is assumed.
1Tx on the first carrier in the first band and 1Tx on a third carrier in a third band is assumed.
1Tx on the first carrier in the first band and 1Tx on a fourth carrier in a fourth band is assumed.

Note that the above embodiments including CA option 1 and CA option 2 can also be applied for Supplementary Uplink (SUL) operation. In another option, the above embodiments for CA option 1 can be applied for SUL operation.

### Switching Location for Multiple Carrier Tx Switching

As mentioned above, for multi-carrier UL operation, there are certain limitations in current NR system. Current NR system only supports 2 UL bands, it is sufficient to configure carrier 1 or carrier 2 for a carrier in a UL band, and configure whether the switching gap is located on the carrier in the UL band.

| | |
|---|---|
| UplinkTxSwitching-r16 ::= | SEQUENCE { |
| uplinkTxSwitchingPeriodLocation-r16 | BOOLEAN, |
| uplinkTxSwitchingCarrier-r16 | ENUMERATED {carrier1, carrier2} |
| } | |

But in case of more than 2 UL bands, for a carrier, gNB may need to configure carrier X, X=1, 2 . . . N, where N is the number of supported UL bands. Moreover, a new mechanism to determine the switch gap location is needed.

In one embodiment, the switching gap on a carrier is configured with condition. For a carrier in a band, gNB may configure whether switching gap on the carrier is supported and the condition to apply the switching gap.

In one option, the condition could be determined by priority indication. For example, if two carries in two bands are with different priorities, the switching gap is on the carrier with lower priority. Assuming 3 UL bands, for 1^{st} UL band, uplinkTxSwitchingPeriodLocation is enabled with priority index=0, for 2^{nd} UL band, uplinkTxSwitchingPeriodLocation is enabled with priority index=1, for 3^{rd} UL band, uplinkTxSwitchingPeriodLocation is enabled with priority index=2. Smaller priority index value represents lower priority. Then, in case of UL band combination of {1^{st} band, 2^{nd} band}, switching gap is on 1^{st} band, while in case of UL band combination of {2^{nd} band, 3^{rd} band}, switching gap is on 2^{nd} band.

In another option, the condition could be determined by band combination configuration. For example, gNB could configure the switching gap presence for each band combination. Assuming 3 UL bands, for 1^{st} UL band, uplinkTxSwitchingPeriodLocation is enabled for combination for {1^{st} band, 2^{nd} band}, thus switching gap is on 1^{st} band for this case, and uplinkTxSwitchingPeriodLocation is disabled for combination for {1^{st} band, 3^{rd} band}, thus switching gap is on 3^{rd} band for this case.

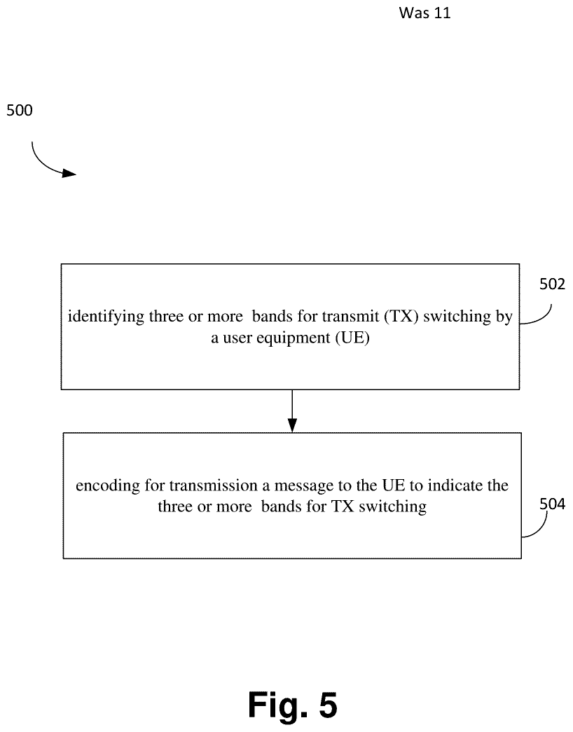

FIG. 5 depicts a process 500 to be performed at an apparatus of a gNB according to an embodiment. Process 500 includes, at operation 502, identifying three or more bands for transmit (TX) switching by a user equipment (UE); and at operation 504, encoding for transmission a message to the UE to indicate the three or more bands for TX switching.

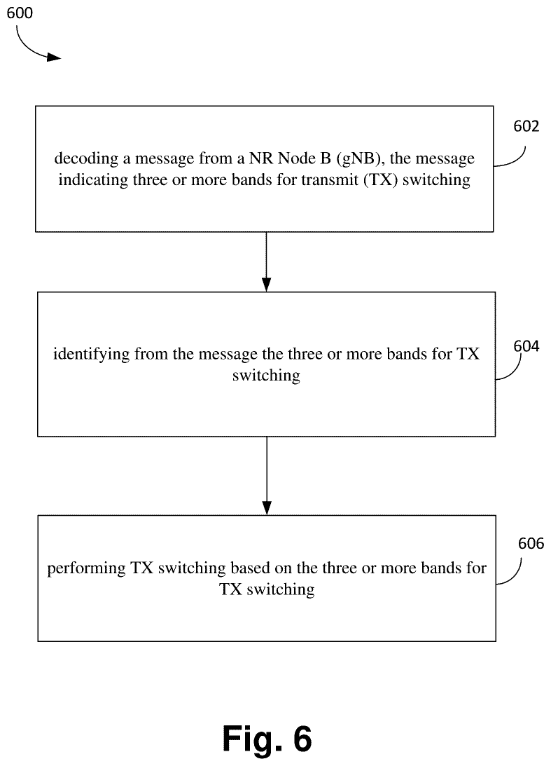

FIG. 6 depicts a process 600 to be performed at an apparatus of a UE according to an embodiment. Process 600 includes, at operation 602, decoding a message from a NR Node B (gNB), the message indicating three or more bands for transmit (TX) switching; at operation 604, identifying from the message the three or more bands for TX switching; and at operation 606, performing TX switching based on the three or more bands for TX switching.

### EXAMPLES

Example 1 include an apparatus of a New Radio (NR) Node B (gNB) including: one or more processors to perform operations including: identifying three or more bands for transmit (TX) switching by a user equipment (UE); and encoding for transmission a message to the UE to indicate the three or more bands for TX switching; and a memory to store the three or more bands for TX switching.

Example 2 includes the subject matter of Example 1, wherein: identifying includes accessing a multi-carrier TX switching table that includes a plurality of multi-carrier TX switching mappings for the UE, individual ones of the mappings including, on one hand, a TX chain configuration of the UE, and one another hand, one or more options for UE uplink (UL) transmission port allocation per band; the TX chain configuration of the UE corresponds to an indication of a number of TX chains configured at the UE per band of the three or more bands; and an individual one of the one or more options for UE UL transmission port allocation per band includes an allocation of one or more antenna ports for UL transmission per band.

Example 3 includes the subject matter of Example 2, wherein a number of the plurality of multi-carrier TX switching mappings for the UE is based on a number of the three or more bands.

Example 4 includes the subject matter of Example 3, wherein the number of the plurality of multi-carrier TX switching mappings for the UE is further based on the TX chain configuration of the UE.

Example 5 includes the subject matter of any one of Examples 2-4, the operations further including, prior to accessing the multi-carrier TX switching table, determining the multi-carrier TX switching table from a plurality of multi-carrier TX switching tables based on a number of the three or more bands.

Example 6 includes the subject matter of Example 5, wherein determining the multi-carrier TX switching table is further based on a determination that the UE is configured for carrier aggregation and not expected to be scheduled or configured with simultaneous UL transmissions on more than one band of the three or more bands.

Example 7 includes the subject matter of Example 6, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, a single option for UE UL transmission port allocation per band including a first allocation corresponding to a single antenna port for the first band, no antenna port for the second band, and no antenna port for the third band (1P+0P+0P); a second multi-carrier TX switching mapping including, on one hand, a second TX chain configuration corresponding to 1T+0T+1T, and on another hand, a single option for UE UL transmission port allocation per band including a second allocation corresponding to 1P+0P+0P; a third multi-carrier TX switching mapping including, on one hand, a third TX chain configuration corresponding to 0T+1T+1T, and on another hand, a single option for UE UL transmission port allocation per band including a third allocation corresponding to 0P+1P+0P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 8 includes the subject matter of Example 6, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, a single option for UE UL transmission port allocation per band including an allocation corresponding to a single antenna port for the first band, no antenna port for the second band, no antenna port for the third band, and no antenna port for the fourth band (1P+0P+0P+0P); a second multi-carrier TX switching mapping including, on one hand, a second TX chain configuration corresponding to 1T+0T+1T+0T, and on another hand, a single option for UE UL transmission port allocation per band including a second allocation corresponding to 1P+0P+0P+0P; a third multi-carrier TX switching mapping including, on one hand, a third TX chain configuration corresponding to 1T+0T+0T+1T, and on another hand, a single options for UE UL transmission port allocation per band including a third allocation corresponding to 1P+0P+0P+0P; a fourth multi-carrier TX switching mapping including, on one hand, a fourth TX chain configuration corresponding to 0T+1T+1T+0T, and on another hand, a single option for UE UL transmission port allocation per band including a fourth allocation corresponding to 0P+1P+0P+0P; a fifth multi-carrier TX switching mapping including, on one hand, a fifth TX chain configuration corresponding to 0T+1T+0T+1T, and on another hand, a single option for UE UL transmission port allocation per band including a fifth allocations corresponding to 0P+1P+0P+0P; a sixth multi-carrier TX switching mapping including, on one hand, a sixth TX chain configuration corresponding to 0T+0T+1T+1T, and on another hand, a single option for UE UL transmission port allocation per band including a sixth allocation corresponding to 0P+0P+1P+0P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 9 includes the subject matter of Example 5, wherein determining the multi-carrier TX switching table is further based on a determination that the UE is configured for carrier aggregation and expected to be scheduled or configured with simultaneous UL transmissions on more than one band of the three or more bands.

Example 10 includes the subject matter of Example 9, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, three options for UE UL transmission port allocation per band including three first allocations corresponding to, respectively, a first option including a single antenna port for the first band, no antenna port for the second band, and no antenna port for the third band (1P+0P+0P), a second option including 1P+1P+0P and a third option including 0P+1P+0P; a second multi-carrier TX switching mapping including, on one hand, a second TX chain configuration corresponding to 1T+0T+1T, and on another hand, three options for UE UL transmission port allocation per band including three second allocations corresponding to, respectively, 1P+0P+0P, 1P+0P+1P and 0P+0P+1P; a third multi-carrier TX switching mapping including, on one hand, a third TX chain configuration corresponding to 0T+1T+1T, and on another hand, three options for UE UL transmission port allocation per band including three third allocations corresponding to, respectively, 0P+1P+0P, 0P+1P+1P and 0P+0P+1P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 11 includes the subject matter of Example 9, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, three options for UE UL transmission port allocation per band including three first allocations corresponding to, respectively, a first option including a single antenna port for the first band, no antenna port for the second band, no antenna port for the third band, and no antenna port for the fourth band (1P+0P+0P+0P), a second option including 1P+1P+0P+0P and a third option including 0P+1P+0P+0P; a second multi-carrier TX switching mapping including, on one hand, a second TX chain configuration corresponding to 1T+0T+1T+0T, and on another hand, three options for UE UL transmission port allocation per band including three second allocations corresponding to, respectively, 1P+0P+0P+0P, 1P+0P+1P+0P and 0P+0P+1P+0P; a third multi-carrier TX switching mapping including, on one hand, a third TX chain configuration corresponding to 1T+0T+0T+1T, and on another hand, three options for UE UL transmission port allocation per band including three third allocations corresponding to, respectively, 1P+0P+0P+0P, 1P+0P+0P+1P and 0P+0P+0P+1P; a fourth multi-carrier TX switching mapping including, on one hand, a fourth TX chain configuration corresponding to 0T+1T+1T+0T, and on another hand, three options for UE UL transmission port allocation per band including three fourth allocations corresponding to, respectively, 0P+1P+0P+0P, 0P+1P+1P+0P and 0P+0P+1P+0P; a fifth multi-carrier TX switching mapping including, on one hand, a fifth TX chain configuration corresponding to 0T+1T+0T+1T, and on another hand, three options for UE UL transmission port allocation per band including three fifth allocations corresponding to, respectively, 0P+1P+0P+0P, 0P+1P+0P+1P and 0P+0P+0P+1P; a sixth multi-carrier TX switching mapping including, on one hand, a sixth TX chain configuration corresponding to 0T+0T+1T+1T, and on another hand, three options for UE UL transmission port allocation per band including three sixth allocations corresponding to, respectively, 0P+0P+1P+0P, 0P+0P+1P+1P and 0P+0P+0P+1P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 12 includes the subject matter of Example 9, the operations further including identifying a delay for the TX switching (TX switching delay) at least one of: in response to a determination that a current TX chain configuration of the UE corresponds to a single TX chain (1T) on a first carrier in a first band of the three or more bands, and 1T on a second carrier in a second band of the three or more bands, in which case the message is to configure the UE to switch a next UL transmission to a 2 antenna port transmission on either the first carrier in the first band or the second carrier in the second band; in response to a determination that a current TX chain configuration of the UE corresponds to 1T on a first carrier in the first band and 1T on a second carrier in the second band, in which case the message is to configure the UE to switch a next UL transmission to a 2 antenna port transmission on a third carrier in a third band of the three or more bands; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the first carrier in the first band and 1-port transmission on the third carrier in the third band; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the second carrier in the second band and 1-port transmission on the third carrier in the third band; in response to a determination that a current TX chain configuration of the UE corresponds to 1T on the first carrier in the first band and 1T on the second carrier in the second band, the next UL transmission has 1-port transmission on the third carrier in a third band; in response to a determination that a current TX chain configuration of the UE corresponds to 0Tx on the first carrier in the first band and 2Tx on the second carrier in the second band, in which case the message is to configure the UE to switch a next UL transmission to a 1 antenna port transmission or to a 2 antenna port transmission on the first carrier in the first band; or in response to a determination that a current TX chain configuration of the UE corresponds to 2Tx on the first carrier in the first band and 0Tx on the second carrier in the second band, in which case the message is to configure the UE to switch a next UL transmission to a 1 antenna port transmission or to a 2 antenna port transmission on the second carrier in the second band.

Example 13 includes the subject matter of any one of Examples 1-4, further including a Radio Frequency (RF) interface coupled to the one or more processors, and a front end module coupled to the RF interface.

Example 14 includes the subject matter of Example 13, further including one or more antennas coupled to the front end module to transmit the PDCCH.

Example 15 includes one or more non-transitory computer-readable media comprising instructions to cause one or more processors of a New Radio (NR) Node B (gNB), upon execution of the instructions, to perform operations including: identifying three or more bands for transmit (TX) switching by a user equipment (UE); and encoding for transmission a message to the UE to indicate the three or more bands for TX switching.

Example 16 includes the subject matter of Example 15, wherein: identifying includes accessing a multi-carrier TX switching table that includes a plurality of multi-carrier TX switching mappings for the UE, individual ones of the mappings including, on one hand, a TX chain configuration of the UE, and one another hand, one or more options for UE uplink (UL) transmission port allocation per band; the TX chain configuration of the UE corresponds to an indication of a number of TX chains configured at the UE per band of the three or more bands; and an individual one of the one or more options for UE UL transmission port allocation per band includes an allocation of one or more antenna ports for UL transmission per band.

Example 17 includes the subject matter of Example 16, wherein a number of the plurality of multi-carrier TX switching mappings for the UE is based on a number of the three or more bands.

Example 18 includes the subject matter of Example 17, wherein the number of the plurality of multi-carrier TX switching mappings for the UE is further based on the TX chain configuration of the UE.

Example 19 includes the subject matter of any one of Examples 16-18, the operations further including, prior to accessing the multi-carrier TX switching table, determining the multi-carrier TX switching table from a plurality of multi-carrier TX switching tables based on a number of the three or more bands.

Example 20 includes the subject matter of Example 19, wherein determining the multi-carrier TX switching table is further based on a determination that the UE is configured for carrier aggregation and not expected to be scheduled or configured with simultaneous UL transmissions on more than one band of the three or more bands.

Example 21 includes the subject matter of Example 20, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, a single option for UE UL transmission port allocation per band including a first allocation corresponding to a single antenna port for the first band, no antenna port for the second band, and no antenna port for the third band (1P+0P+0P); a second multi-carrier TX switching mapping including, on one hand, a second TX chain configuration corresponding to 1T+0T+1T, and on another hand, a single option for UE UL transmission port allocation per band including a second allocation corresponding to 1P+0P+0P; a third multi-carrier TX switching mapping including, on one hand, a third TX chain configuration corresponding to 0T+1T+1T, and on another hand, a single option for UE UL transmission port allocation per band including a third allocation corresponding to 0P+1P+0P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 22 includes the subject matter of Example 20, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, a single option for UE UL transmission port allocation per band including an allocation corresponding to a single antenna port for the first band, no antenna port for the second band, no antenna port for the third band, and no antenna port for the fourth band (1P+0P+0P+0P); a second multi-carrier TX switching mapping including, on one hand, a second TX chain configuration corresponding to 1T+0T+1T+0T, and on another hand, a single option for UE UL transmission port allocation per band including a second allocation corresponding to 1P+0P+0P+0P; a third multi-carrier TX switching mapping including, on one hand, a third TX chain configuration corresponding to 1T+0T+0T+1T, and on another hand, a single options for UE UL transmission port allocation per band including a third allocation corresponding to 1P+0P+0P+0P; a fourth multi-carrier TX switching mapping including, on one hand, a fourth TX chain configuration corresponding to 0T+1T+1T+0T, and on another hand, a single option for UE UL transmission port allocation per band including a fourth allocation corresponding to 0P+1P+0P+0P; a fifth multi-carrier TX switching mapping including, on one hand, a fifth TX chain configuration corresponding to 0T+1T+0T+1T, and on another hand, a single option for UE UL transmission port allocation per band including a fifth allocations corresponding to 0P+1P+0P+0P; a sixth multi-carrier TX switching mapping including, on one hand, a sixth TX chain configuration corresponding to 0T+0T+1T+1T, and on another hand, a single option for UE UL transmission port allocation per band including a sixth allocation corresponding to 0P+0P+1P+0P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 23 includes the subject matter of Example 19, wherein determining the multi-carrier TX switching table is further based on a determination that the UE is configured for carrier aggregation and expected to be scheduled or configured with simultaneous UL transmissions on more than one band of the three or more bands.

Example 24 includes the subject matter of Example 23, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, three options for UE UL transmission port allocation per band including three first allocations corresponding to, respectively, a first option including a single antenna port for the first band, no antenna port for the second band, and no antenna port for the third band (1P+0P+0P), a second option including 1P+1P+0P and a third option including 0P+1P+0P; a second multi-carrier TX switching mapping including, on one hand, a second TX chain configuration corresponding to 1T+0T+1T, and on another hand, three options for UE UL transmission port allocation per band including three second allocations corresponding to, respectively, 1P+0P+0P, 1P+0P+1P and 0P+0P+1P; a third multi-carrier TX switching mapping including, on one hand, a third TX chain configuration corresponding to 0T+1T+1T, and on another hand, three options for UE UL transmission port allocation per band including three third allocations corresponding to, respectively, 0P+1P+0P, 0P+1P+1P and 0P+0P+1P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 25 includes the subject matter of Example 23, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, three options for UE UL transmission port allocation per band including three first allocations corresponding to, respectively, a first option including a single antenna port for the first band, no antenna port for the second band, no antenna port for the third band, and no antenna port for the fourth band (1P+0P+0P+0P), a second option including 1P+1P+0P+0P and a third option including 0P+1P+0P+0P; a second multi-carrier TX switching mapping including, on one hand, a second TX chain configuration corresponding to 1T+0T+1T+0T, and on another hand, three options for UE UL transmission port allocation per band including three second allocations corresponding to, respectively, 1P+0P+0P+0P, 1P+0P+1P+0P and 0P+0P+1P+0P; a third multi-carrier TX switching mapping including, on one hand, a third TX chain configuration corresponding to 1T+0T+0T+1T, and on another hand, three options for UE UL transmission port allocation per band including three third allocations corresponding to, respectively, 1P+0P+0P+0P, 1P+0P+0P+1P and 0P+0P+0P+1P; a fourth multi-carrier TX switching mapping including, on one hand, a fourth TX chain configuration corresponding to 0T+1T+1T+0T, and on another hand, three options for UE UL transmission port allocation per band including three fourth allocations corresponding to, respectively, 0P+1P+0P+0P, 0P+1P+1P+0P and 0P+0P+1P+0P; a fifth multi-carrier TX switching mapping including, on one hand, a fifth TX chain configuration corresponding to 0T+1T+0T+1T, and on another hand, three options for UE UL transmission port allocation per band including three fifth allocations corresponding to, respectively, 0P+1P+0P+0P, 0P+1P+0P+1P and 0P+0P+0P+1P; a sixth multi-carrier TX switching mapping including, on one hand, a sixth TX chain configuration corresponding to 0T+0T+1T+1T, and on another hand, three options for UE UL transmission port allocation per band including three sixth allocations corresponding to, respectively, 0P+0P+1P+0P, 0P+0P+1P+1P and 0P+0P+0P+1P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 26 includes the subject matter of Example 23, the operations further including identifying a delay for the TX switching (TX switching delay) at least one of: in response to a determination that a current TX chain configuration of the UE corresponds to a single TX chain (1T) on a first carrier in a first band of the three or more bands, and 1T on a second carrier in a second band of the three or more bands, in which case the message is to configure the UE to switch a next UL transmission to a 2 antenna port transmission on either the first carrier in the first band or the second carrier in the second band; in response to a determination that a current TX chain configuration of the UE corresponds to 1T on a first carrier in the first band and 1T on a second carrier in the second band, in which case the message is to configure the UE to switch a next UL transmission to a 2 antenna port transmission on a third carrier in a third band of the three or more bands; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the first carrier in the first band and 1-port transmission on the third carrier in the third band; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the second carrier in the second band and 1-port transmission on the third carrier in the third band; in response to a determination that a current TX chain configuration of the UE corresponds to 1T on the first carrier in the first band and 1T on the second carrier in the second band, the next UL transmission has 1-port transmission on the third carrier in a third band; in response to a determination that a current TX chain configuration of the UE corresponds to 0Tx on the first carrier in the first band and 2Tx on the second carrier in the second band, in which case the message is to configure the UE to switch a next UL transmission to a 1 antenna port transmission or to a 2 antenna port transmission on the first carrier in the first band; or in response to a determination that a current TX chain configuration of the UE corresponds to 2Tx on the first carrier in the first band and 0Tx on the second carrier in the second band, in which case the message is to configure the UE to switch a next UL transmission to a 1 antenna port transmission or to a 2 antenna port transmission on the second carrier in the second band.

Example 27 include a method to be performed at one or more processors of a New Radio (NR) Node B (gNB), the method including: identifying three or more bands for transmit (TX) switching by a user equipment (UE); and encoding for transmission a message to the UE to indicate the three or more bands for TX switching.

Example 28 includes the subject matter of Example 27, wherein: identifying includes accessing a multi-carrier TX switching table that includes a plurality of multi-carrier TX switching mappings for the UE, individual ones of the mappings including, on one hand, a TX chain configuration of the UE, and one another hand, one or more options for UE uplink (UL) transmission port allocation per band; the TX chain configuration of the UE corresponds to an indication of a number of TX chains configured at the UE per band of the three or more bands; and an individual one of the one or more options for UE UL transmission port allocation per band includes an allocation of one or more antenna ports for UL transmission per band.

Example 29 includes the subject matter of Example 28, wherein a number of the plurality of multi-carrier TX switching mappings for the UE is based on a number of the three or more bands.

Example 30 includes the subject matter of Example 29, wherein the number of the plurality of multi-carrier TX switching mappings for the UE is further based on the TX chain configuration of the UE.

Example 31 includes the subject matter of any one of Examples 28-30, further including, prior to accessing the multi-carrier TX switching table, determining the multi-carrier TX switching table from a plurality of multi-carrier TX switching tables based on a number of the three or more bands.

Example 32 includes the subject matter of Example 31, wherein determining the multi-carrier TX switching table is further based on a determination that the UE is configured for carrier aggregation and not expected to be scheduled or configured with simultaneous UL transmissions on more than one band of the three or more bands.

Example 33 includes the subject matter of Example 32, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, a single option for UE UL transmission port allocation per band including a first allocation corresponding to a single antenna port for the first band, no antenna port for the second band, and no antenna port for the third band (1P+0P+0P); a second multi-carrier TX switching mapping including, on one hand, a second TX chain configuration corresponding to 1T+0T+1T, and on another hand, a single option for UE UL transmission port allocation per band including a second allocation corresponding to 1P+0P+0P; a third multi-carrier TX switching mapping including, on one hand, a third TX chain configuration corresponding to 0T+1T+1T, and on another hand, a single option for UE UL transmission port allocation per band including a third allocation corresponding to 0P+1P+0P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 34 includes the subject matter of Example 32, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, a single option for UE UL transmission port allocation per band including an allocation corresponding to a single antenna port for the first band, no antenna port for the second band, no antenna port for the third band, and no antenna port for the fourth band (1P+0P+0P+0P); a second multi-carrier TX switching mapping including, on one hand, a second TX chain configuration corresponding to 1T+0T+1T+0T, and on another hand, a single option for UE UL transmission port allocation per band including a second allocation corresponding to 1P+0P+0P+0P; a third multi-carrier TX switching mapping including, on one hand, a third TX chain configuration corresponding to 1T+0T+0T+1T, and on another hand, a single options for UE UL transmission port allocation per band including a third allocation corresponding to 1P+0P+0P+0P; a fourth multi-carrier TX switching mapping including, on one hand, a fourth TX chain configuration corresponding to 0T+1T+1T+0T, and on another hand, a single option for UE UL transmission port allocation per band including a fourth allocation corresponding to 0P+1P+0P+0P; a fifth multi-carrier TX switching mapping including, on one hand, a fifth TX chain configuration corresponding to 0T+1T+0T+1T, and on another hand, a single option for UE UL transmission port allocation per band including a fifth allocations corresponding to 0P+1P+0P+0P; a sixth multi-carrier TX switching mapping including, on one hand, a sixth TX chain configuration corresponding to 0T+0T+1T+1T, and on another hand, a single option for UE UL transmission port allocation per band including a sixth allocation corresponding to 0P+0P+1P+0P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 35 includes the subject matter of Example 32, wherein determining the multi-carrier TX switching table is further based on a determination that the UE is configured for carrier aggregation and expected to be scheduled or configured with simultaneous UL transmissions on more than one band of the three or more bands.

Example 36 includes the subject matter of Example 35, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, three options for UE UL transmission port allocation per band including three first allocations corresponding to, respectively, a first option including a single antenna port for the first band, no antenna port for the second band, and no antenna port for the third band (1P+0P+0P), a second option including 1P+1P+0P and a third option including 0P+1P+0P; a second multi-carrier TX switching mapping including, on one hand, a second TX chain configuration corresponding to 1T+0T+1T, and on another hand, three options for UE UL transmission port allocation per band including three second allocations corresponding to, respectively, 1P+0P+0P, 1P+0P+1P and 0P+0P+1P; a third multi-carrier TX switching mapping including, on one hand, a third TX chain configuration corresponding to 0T+1T+1T, and on another hand, three options for UE UL transmission port allocation per band including three third allocations corresponding to, respectively, 0P+1P+0P, 0P+1P+1P and 0P+0P+1P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 37 includes the subject matter of Example 35, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, three options for UE UL transmission port allocation per band including three first allocations corresponding to, respectively, a first option including a single antenna port for the first band, no antenna port for the second band, no antenna port for the third band, and no antenna port for the fourth band (1P+0P+0P+0P), a second option including 1P+1P+0P+0P and a third option including 0P+1P+0P+0P; a second multi-carrier TX switching mapping including, on one hand, a second TX chain configuration corresponding to 1T+0T+1T+0T, and on another hand, three options for UE UL transmission port allocation per band including three second allocations corresponding to, respectively, 1P+0P+0P+0P, 1P+0P+1P+0P and 0P+0P+1P+0P; a third multi-carrier TX switching mapping including, on one hand, a third TX chain configuration corresponding to 1T+0T+0T+1T, and on another hand, three options for UE UL transmission port allocation per band including three third allocations corresponding to, respectively, 1P+0P+0P+0P, 1P+0P+0P+1P and 0P+0P+0P+1P; a fourth multi-carrier TX switching mapping including, on one hand, a fourth TX chain configuration corresponding to 0T+1T+1T+0T, and on another hand, three options for UE UL transmission port allocation per band including three fourth allocations corresponding to, respectively, 0P+1P+0P+0P, 0P+1P+1P+0P and 0P+0P+1P+0P; a fifth multi-carrier TX switching mapping including, on one hand, a fifth TX chain configuration corresponding to 0T+1T+0T+1T, and on another hand, three options for UE UL transmission port allocation per band including three fifth allocations corresponding to, respectively, 0P+1P+0P+0P, 0P+1P+0P+1P and 0P+0P+0P+1P; a sixth multi-carrier TX switching mapping including, on one hand, a sixth TX chain configuration corresponding to 0T+0T+1T+1T, and on another hand, three options for UE UL transmission port allocation per band including three sixth allocations corresponding to, respectively, 0P+0P+1P+0P, 0P+0P+1P+1P and 0P+0P+0P+1P; a seventh multi-carrier TX switching: mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 38 includes the subject matter of Example 35, further including identifying a delay for the TX switching (TX switching delay) at least one of: in response to a determination that a current TX chain configuration of the UE corresponds to a single TX chain (1T) on a first carrier in a first band of the three or more bands, and 1T on a second carrier in a second band of the three or more bands, in which case the message is to configure the UE to switch a next UL transmission to a 2 antenna port transmission on either the first carrier in the first band or the second carrier in the second band; in response to a determination that a current TX chain configuration of the UE corresponds to 1T on a first carrier in the first band and 1T on a second carrier in the second band, in which case the message is to configure the UE to switch a next UL transmission to a 2 antenna port transmission on a third carrier in a third band of the three or more bands; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the first carrier in the first band and 1-port transmission on the third carrier in the third band; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the second carrier in the second band and 1-port transmission on the third carrier in the third band; in response to a determination that a current TX chain configuration of the UE corresponds to 1T on the first carrier in the first band and 1T on the second carrier in the second band, the next UL transmission has 1-port transmission on the third carrier in a third band; in response to a determination that a current TX chain configuration of the UE corresponds to 0Tx on the first carrier in the first band and 2Tx on the second carrier in the second band, in which case the message is to configure the UE to switch a next UL transmission to a 1 antenna port transmission or to a 2 antenna port transmission on the first carrier in the first band; or in response to a determination that a current TX chain configuration of the UE corresponds to 2Tx on the first carrier in the first band and 0Tx on the second carrier in the second band, in which case the message is to configure the UE to switch a next UL transmission to a 1 antenna port transmission or to a 2 antenna port transmission on the second carrier in the second band.

Example 39 include an apparatus of a New Radio (NR) User Equipment (UE) including: one or more processors to perform operations including: decoding a message from a NR Node B (gNB), the message indicating three or more bands for transmit (TX) switching; identifying from the message the three or more bands for TX switching; and performing TX switching based on the three or more bands for TX switching; and a memory to store the three or more bands for TX switching.

Example 40 includes the subject matter of Example 39, wherein: identifying includes accessing a multi-carrier TX switching table that includes a plurality of multi-carrier TX switching mappings for the UE, individual ones of the mappings including, on one hand, a TX chain configuration of the UE, and one another hand, one or more options for UE uplink (UL) transmission port allocation per band; the TX chain configuration of the UE corresponds to an indication of a number of TX chains configured at the UE per band of the three or more bands; and an individual one of the one or more options for UE UL transmission port allocation per band includes an allocation of one or more antenna ports for UL transmission per band.

Example 41 includes the subject matter of Example 40, wherein a number of the plurality of multi-carrier TX switching mappings for the UE is based on a number of the three or more bands.

Example 42 includes the subject matter of Example 41, wherein the number of the plurality of multi-carrier TX switching mappings for the UE is further based on the TX chain configuration of the UE.

Example 43 includes the subject matter of any one of Examples 40-42, the operations further including, prior to accessing the multi-carrier TX switching table, determining the multi-carrier TX switching table from a plurality of multi-carrier TX switching tables based on a number of the three or more bands.

Example 44 includes the subject matter of Example 43, wherein determining the multi-carrier TX switching table is further based on a determination that the UE is configured for carrier aggregation and not expected to be scheduled or configured with simultaneous UL transmissions on more than one band of the three or more bands.

Example 45 includes the subject matter of Example 44, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, a single option for UE UL transmission port allocation per band including a first allocation corresponding to a single antenna port for the first band, no antenna port for the second band, and no antenna port for the third band (1P+0P+0P); a second multi-carrier TX switching mapping including, on one hand, a second TX chain configuration corresponding to 1T+0T+1T, and on another hand, a single option for UE UL transmission port allocation per band including a second allocation corresponding to 1P+0P+0P; a third multi-carrier TX switching mapping including, on one hand, a third TX chain configuration corresponding to 0T+1T+1T, and on another hand, a single option for UE UL transmission port allocation per band including a third allocation corresponding to 0P+1P+0P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 46 includes the subject matter of Example 44, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, a single option for UE UL transmission port allocation per band including an allocation corresponding to a single antenna port for the first band, no antenna port for the second band, no antenna port for the third band, and no antenna port for the fourth band (1P+0P+0P+0P); a second multi-carrier TX switching mapping including, on one hand, a second TX chain configuration corresponding to 1T+0T+1T+0T, and on another hand, a single option for UE UL transmission port allocation per band including a second allocation corresponding to 1P+0P+0P+0P; a third multi-carrier TX switching mapping including, on one hand, a third TX chain configuration corresponding to 1T+0T+0T+1T, and on another hand, a single options for UE UL transmission port allocation per band including a third allocation corresponding to 1P+0P+0P+0P; a fourth multi-carrier TX switching mapping including, on one hand, a fourth TX chain configuration corresponding to 0T+1T+1T+0T, and on another hand, a single option for UE UL transmission port allocation per band including a fourth allocation corresponding to 0P+1P+0P+0P; a fifth multi-carrier TX switching mapping including, on one hand, a fifth TX chain configuration corresponding to 0T+1T+0T+1T, and on another hand, a single option for UE UL transmission port allocation per band including a fifth: allocations corresponding to 0P+1P+0P+0P; a sixth multi-carrier TX switching mapping including, on one hand, a sixth TX chain configuration corresponding to 0T+0T+1T+1T, and on another hand, a single option for UE UL transmission port allocation per band including a sixth allocation corresponding to 0P+0P+1P+0P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 47 includes the subject matter of Example 43, wherein determining the multi-carrier TX switching table is further based on a determination that the UE is configured for carrier aggregation and expected to be scheduled or configured with simultaneous UL transmissions on more than one band of the three or more bands.

Example 48 includes the subject matter of Example 47, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, three options for UE UL transmission port allocation per band including three first allocations corresponding to, respectively, a first option including a single antenna port for the first band, no antenna port for the second band, and no antenna port for the third band (1P+0P+0P), a second option including 1P+1P+0P and a third option including 0P+1P+0P; a second multi-carrier TX switching mapping including, on one hand, a second TX chain configuration corresponding to 1T+0T+1T, and on another hand, three options for UE UL transmission port allocation per band including three second allocations corresponding to, respectively, 1P+0P+0P, 1P+0P+1P and 0P+0P+1P; a third multi-carrier TX switching mapping including, on one hand, a third TX chain configuration corresponding to 0T+1T+1T, and on another hand, three options for UE UL transmission port allocation per band including three third allocations corresponding to, respectively, 0P+1P+0P, 0P+1P+1P and 0P+0P+1P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 49 includes the subject matter of Example 47, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, three options for UE UL transmission port allocation per band including three first allocations corresponding to, respectively, a first option: including a single antenna port for the first band, no antenna port for the second band, no antenna port for the third band, and no antenna port for the fourth band (1P+0P+0P+0P), a second option including 1P+1P+0P+0P and a third option including 0P+1P+0P+0P; a second multi-carrier TX switching mapping including, on one hand, a second TX chain configuration corresponding to 1T+0T+1T+0T, and on another hand, three options for UE UL transmission port allocation per band including three second allocations corresponding to, respectively, 1P+0P+0P+0P, 1P+0P+1P+0P and 0P+0P+1P+0P; a third multi-carrier TX switching mapping including, on one hand, a third TX chain configuration corresponding to 1T+0T+0T+1T, and on another hand, three options for UE UL transmission port allocation per band including three third allocations corresponding to, respectively, 1P+0P+0P+0P, 1P+0P+0P+1P and 0P+0P+0P+1P; a fourth multi-carrier TX switching mapping including, on one hand, a fourth TX chain configuration corresponding to 0T+1T+1T+0T, and on another hand, three options for UE UL transmission port allocation per band including three fourth allocations corresponding to, respectively, 0P+1P+0P+0P, 0P+1P+1P+0P and 0P+0P+1P+0P; a fifth multi-carrier TX switching mapping including, on one hand, a fifth TX chain configuration corresponding to 0T+1T+0T+1T, and on another hand, three options for UE UL transmission port allocation per band including three fifth allocations corresponding to, respectively, 0P+1P+0P+0P, 0P+1P+0P+1P and 0P+0P+0P+1P; a sixth multi-carrier TX switching mapping including, on one hand, a sixth TX chain configuration corresponding to 0T+0T+1T+1T, and on another hand, three options for UE UL transmission port allocation per band including three sixth allocations corresponding to, respectively, 0P+0P+1P+0P, 0P+0P+1P+1P and 0P+0P+0P+1P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 50 includes the subject matter of Example 47, the operations further including identifying a delay for the TX switching (TX switching delay) at least one of: in response to a determination that a current TX chain configuration of the UE corresponds to a single TX chain (1T) on a first carrier in a first band of the three or more bands, and 1T on a second carrier in a second band of the three or more bands, in which case the message is to configure the UE to switch a next UL transmission to a 2 antenna port transmission on either the first carrier in the first band or the second carrier in the second band; in response to a determination that a current TX chain configuration of the UE corresponds to 1T on a first carrier in the first band and 1T on a second carrier in the second band, in which case the message is to configure the UE to switch a next UL transmission to a 2 antenna port transmission on a third carrier in a third band of the three or more bands; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the first carrier in the first band and 1-port transmission on the third carrier in the third band; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the second carrier in the second band and 1-port transmission on the third carrier in the third band; in response to a determination that a current TX chain configuration of the UE corresponds to 1T on the first carrier in the first band and 1T on the second carrier in the second band, the next UL transmission has 1-port transmission on the third carrier in a third band; in response to a determination that a current TX chain configuration of the UE corresponds to 0Tx on the first carrier in the first band and 2Tx on the second carrier in the second band, in which case the message is to configure the UE to switch a next UL transmission to a 1 antenna port transmission or to a 2 antenna port transmission on the first carrier in the first band; or in response to a determination that a current TX chain configuration of the UE corresponds to 2Tx on the first carrier in the first band and 0Tx on the second carrier in the second band, in which case the message is to configure the UE to switch a next UL transmission to a 1 antenna port transmission or to a 2 antenna port transmission on the second carrier in the second band.

Example 51 includes the subject matter of any one of Examples 39-42, further including a Radio Frequency (RF) interface coupled to the one or more processors, and a front end module coupled to the RF interface.

Example 52 includes the subject matter of Example 51, further including one or more antennas coupled to the front end module to transmit the PDCCH.

Example 53 include a method to be performed at an apparatus of a New Radio (NR) User Equipment (UE), the method including: decoding a message from a NR Node B (gNB), the message indicating three or more bands for transmit (TX) switching; identifying from the message the three or more bands for TX switching; and performing TX switching based on the three or more bands for TX switching.

Example 54 includes the subject matter of Example 53, wherein: identifying includes accessing a multi-carrier TX switching table that includes a plurality of multi-carrier TX switching mappings for the UE, individual ones of the mappings including, on one hand, a TX chain configuration of the UE, and one another hand, one or more options for UE uplink (UL) transmission port allocation per band; the TX chain configuration of the UE corresponds to an indication of a number of TX chains configured at the UE per band of the three or more bands; and an individual one of the one or more options for UE UL transmission port allocation per band includes an allocation of one or more antenna ports for UL transmission per band.

Example 55 includes the subject matter of Example 54, wherein a number of the plurality of multi-carrier TX switching mappings for the UE is based on a number of the three or more bands.

Example 56 includes the subject matter of Example 55, wherein the number of the plurality of multi-carrier TX switching mappings for the UE is further based on the TX chain configuration of the UE.

Example 57 includes the subject matter of any one of Examples 54-56, further including, prior to accessing the multi-carrier TX switching table, determining the multi-carrier TX switching table from a plurality of multi-carrier TX switching tables based on a number of the three or more bands.

Example 58 includes the subject matter of Example 57, wherein determining the multi-carrier TX switching table is further based on a determination that the UE is configured for carrier aggregation and not expected to be scheduled or configured with simultaneous UL transmissions on more than one band of the three or more bands.

Example 59 includes the subject matter of Example 58, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, a single option for UE UL transmission port allocation per band including a first allocation corresponding to a single antenna port for the first band, no antenna port for the second band, and no antenna port for the third band (1P+0P+0P); a second multi-carrier TX switching mapping including, on one hand, a second TX chain configuration corresponding to 1T+0T+1T, and on another hand, a single option for UE UL transmission port allocation per band including a second allocation corresponding to 1P+0P+0P; a third multi-carrier TX switching mapping including, on one hand, a third TX chain configuration corresponding to 0T+1T+1T, and on another hand, a single option for UE UL transmission port allocation per band including a third allocation corresponding to 0P+1P+0P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 60 includes the subject matter of Example 58, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, a single option for UE UL transmission port allocation per band including an allocation corresponding to a single antenna port for the first band, no antenna port for the second band, no antenna port for the third band, and no antenna port for the fourth band (1P+0P+0P+0P); a second multi-carrier TX switching mapping including, on one hand, a second TX chain configuration corresponding to 1T+0T+1T+0T, and on another hand, a single option for UE UL transmission port allocation per band including a second allocation corresponding to 1P+0P+0P+0P; a third multi-carrier TX switching mapping including, on one hand, a third TX chain configuration corresponding to 1T+0T+0T+1T, and on another hand, a single options for UE UL transmission port allocation per band including a third allocation corresponding to 1P+0P+0P+0P; a fourth multi-carrier TX switching mapping including, on one hand, a fourth TX chain configuration corresponding to 0T+1T+1T+0T, and on another hand, a single option for UE UL transmission port allocation per band including a fourth allocation corresponding to 0P+1P+0P+0P; a fifth multi-carrier TX switching mapping including, on one hand, a fifth TX chain configuration corresponding to 0T+1T+0T+1T, and on another hand, a single option for UE UL transmission port allocation per band including a fifth allocations corresponding to 0P+1P+0P+0P; a sixth multi-carrier TX switching mapping including, on one hand, a sixth TX chain configuration corresponding to 0T+0T+1T+1T, and on another hand, a single option for UE UL transmission port allocation per band including a sixth allocation corresponding to 0P+0P+1P+0P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 61 includes the subject matter of Example 57, wherein determining the multi-carrier TX switching table is further based on a determination that the UE is configured for carrier aggregation and expected to be scheduled or configured with simultaneous UL transmissions on more than one band of the three or more bands.

Example 62 includes the subject matter of Example 61, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, three options for UE UL transmission port allocation per band including three first allocations corresponding to, respectively, a first option including a single antenna port for the first band, no antenna port for the second band, and no antenna port for the third band (1P+0P+0P), a second option including 1P+1P+0P and a third option including 0P+1P+0P; a second multi-carrier TX switching mapping including, on one hand, a second TX chain configuration corresponding to 1T+0T+1T, and on another hand, three options for UE UL transmission port allocation per band including three second allocations corresponding to, respectively, 1P+0P+0P, 1P+0P+1P and 0P+0P+1P; a third multi-carrier TX switching mapping including, on one hand, a third TX chain configuration corresponding to 0T+1T+1T, and on another hand, three options for UE UL transmission port allocation per band including three third allocations corresponding to, respectively, 0P+1P+0P, 0P+1P+1P and 0P+0P+1P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 63 includes the subject matter of Example 61, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, three options for UE UL transmission port allocation per band including three first allocations corresponding to, respectively, a first option including a single antenna port for the first band, no antenna port for the second band, no antenna port for the third band, and no antenna port for the fourth band (1P+0P+0P+0P), a second option including 1P+1P+0P+0P and a third option including 0P+1P+0P+0P; a second multi-carrier TX switching mapping including, on one hand, a second TX chain configuration corresponding to 1T+0T+1T+0T, and on another hand, three options for UE UL transmission port allocation per band including three second allocations corresponding to, respectively, 1P+0P+0P+0P, 1P+0P+1P+0P and 0P+0P+1P+0P; a third multi-carrier TX switching mapping including, on one hand, a third TX chain configuration corresponding to 1T+0T+0T+1T, and on another hand, three options for UE UL transmission port allocation per band including three third allocations corresponding to, respectively, 1P+0P+0P+0P, 1P+0P+0P+1P and 0P+0P+0P+1P; a fourth multi-carrier TX switching mapping including, on one hand, a fourth TX chain configuration corresponding to 0T+1T+1T+0T, and on another hand, three options for UE UL transmission port allocation per band including three fourth allocations corresponding to, respectively, 0P+1P+0P+0P, 0P+1P+1P+0P and 0P+0P+1P+0P; a fifth multi-carrier TX switching mapping including, on one hand, a fifth TX chain configuration corresponding to 0T+1T+0T+1T, and on another hand, three options for UE UL transmission port allocation per band including three fifth allocations corresponding to, respectively, 0P+1P+0P+0P, 0P+1P+0P+1P and 0P+0P+0P+1P; a sixth multi-carrier TX switching mapping including, on one hand, a sixth TX chain configuration corresponding to 0T+0T+1T+1T, and on another hand, three options for UE UL transmission port allocation per band including three sixth allocations corresponding to, respectively, 0P+0P+1P+0P, 0P+0P+1P+1P and 0P+0P+0P+1P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 64 includes the subject matter of Example 61, further including identifying a delay for the TX switching (TX switching delay) at least one of: in response to a determination that a current TX chain configuration of the UE corresponds to a single TX chain (1T) on a first carrier in a first band of the three or more bands, and 1T on a second carrier in a second band of the three or more bands, in which case the message is to configure the UE to switch a next UL transmission to a 2 antenna port transmission on either the first carrier in the first band or the second carrier in the second band; in response to a determination that a current TX chain configuration of the UE corresponds to 1T on a first carrier in the first band and 1T on a second carrier in the second band, in which case the message is to configure the UE to switch a next UL transmission to a 2 antenna port transmission on a third carrier in a third band of the three or more bands; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the first carrier in the first band and 1-port transmission on the third carrier in the third band; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the second carrier in the second band and 1-port transmission on the third carrier in the third band; in response to a determination that a current TX chain configuration of the UE corresponds to 1T on the first carrier in the first band and 1T on the second carrier in the second band, the next UL transmission has 1-port transmission on the third carrier in a third band; in response to a determination that a current TX chain configuration of the UE corresponds to 0Tx on the first carrier in the first band and 2Tx on the second carrier in the second band, in which case the message is to configure the UE to switch a next UL transmission to a 1 antenna port transmission or to a 2 antenna port transmission on the first carrier in the first band; or in response to a determination that a current TX chain configuration of the UE corresponds to 2Tx on the first carrier in the first band and 0Tx on the second carrier in the second band, in which case the message is to configure the UE to switch a next UL transmission to a 1 antenna port transmission or to a 2 antenna port transmission on the second carrier in the second band.

Example 65 includes one or more non-transitory computer-readable media comprising instructions to cause one or more processors of a New Radio (NR) User Equipment (UE), upon execution of the instructions, to perform operations including: decoding a message from a NR Node B (gNB), the message indicating three or more bands for transmit (TX) switching; identifying from the message the three or more bands for TX switching; and performing TX switching based on the three or more bands for TX switching.

Example 66 includes the subject matter of Example 65, wherein: identifying includes accessing a multi-carrier TX switching table that includes a plurality of multi-carrier TX switching mappings for the UE, individual ones of the mappings including, on one hand, a TX chain configuration of the UE, and one another hand, one or more options for UE uplink (UL) transmission port allocation per band; the TX chain configuration of the UE corresponds to an indication of a number of TX chains configured at the UE per band of the three or more bands; and an individual one of the one or more options for UE UL transmission port allocation per band includes an allocation of one or more antenna ports for UL transmission per band.

Example 67 includes the subject matter of Example 66, wherein a number of the plurality of multi-carrier TX switching mappings for the UE is based on a number of the three or more bands.

Example 68 includes the subject matter of Example 67, wherein the number of the plurality of multi-carrier TX switching mappings for the UE is further based on the TX chain configuration of the UE.

Example 69 includes the subject matter of any one of Examples 66-68, the operations further including, prior to accessing the multi-carrier TX switching table, determining the multi-carrier TX switching table from a plurality of multi-carrier TX switching tables based on a number of the three or more bands.

Example 70 includes the subject matter of Example 69, wherein determining the multi-carrier TX switching table is further based on a determination that the UE is configured for carrier aggregation and not expected to be scheduled or configured with simultaneous UL transmissions on more than one band of the three or more bands.

Example 71 includes the subject matter of Example 70, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, a single option for UE UL transmission port allocation per band including a first allocation corresponding to a single antenna port for the first band, no antenna port for the second band, and no antenna port for the third band (1P+0P+0P); a second multi-carrier TX switching mapping including, on one hand, a second TX chain configuration corresponding to 1T+0T+1T, and on another hand, a single option for UE UL transmission port allocation per band including a second allocation corresponding to 1P+0P+0P; a third multi-carrier TX switching mapping including, on one hand, a third TX chain configuration corresponding to 0T+1T+1T, and on another hand, a single option for UE UL transmission port allocation per band including a third allocation corresponding to 0P+1P+0P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 72 includes the subject matter of Example 70, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, a single option for UE UL transmission port allocation per band including an allocation corresponding to a single antenna port for the first band, no antenna port for the second band, no antenna port for the third band, and no antenna port for the fourth band (1P+0P+0P+0P); a second multi-carrier TX switching mapping including, on one hand, a second TX chain configuration corresponding to 1T+0T+1T+0T, and on another hand, a single option for UE UL transmission port allocation per band including a second allocation corresponding to 1P+0P+0P+0P; a third multi-carrier TX switching mapping including, on one hand, a third TX chain configuration corresponding to 1T+0T+0T+1T, and on another hand, a single options for UE UL transmission port allocation per band including a third allocation corresponding to 1P+0P+0P+0P; a fourth multi-carrier TX switching mapping including, on one hand, a fourth TX chain configuration corresponding to 0T+1T+1T+0T, and on another hand, a single option for UE UL transmission port allocation per band including a fourth allocation corresponding to 0P+1P+0P+0P; a fifth multi-carrier TX switching mapping including, on one hand, a fifth TX chain configuration corresponding to 0T+1T+0T+1T, and on another hand, a single option for UE UL transmission port allocation per band including a fifth allocations corresponding to 0P+1P+0P+0P; a sixth multi-carrier TX switching mapping including, on one hand, a sixth TX chain configuration corresponding to 0T+0T+1T+1T, and on another hand, a single option for UE UL transmission port allocation per band including a sixth allocation corresponding to 0P+0P+1P+0P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 73 includes the subject matter of Example 69, wherein determining the multi-carrier TX switching table is further based on a determination that the UE is configured for carrier aggregation and expected to be scheduled or configured with simultaneous UL transmissions on more than one band of the three or more bands.

Example 74 includes the subject matter of Example 73, wherein the three or more bands correspond to three bands, and multi-carrier TX switching table includes up to six multi-carrier TX switching mappings for the UE including two or more of: a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, three options for UE UL transmission port allocation per band including three first allocations corresponding to, respectively, a first option including a single antenna port for the first band, no antenna port for the second band, and no antenna port for the third band (1P+0P+0P), a second option including 1P+1P+0P and a third option including 0P+1P+0P; a second multi-carrier TX switching mapping including, on one hand, a second TX chain configuration corresponding to 1T+0T+1T, and on another hand, three options for UE UL transmission port allocation per band including three second allocations corresponding to, respectively, 1P+0P+0P, 1P+0P+1P and 0P+0P+1P; a third multi-carrier TX switching mapping including, on one hand, a third TX chain configuration corresponding to 0T+1T+1T, and on another hand, three options for UE UL transmission port allocation per band including three third allocations corresponding to, respectively, 0P+1P+0P, 0P+1P+1P and 0P+0P+1P; a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P; a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P, wherein TX switching includes switching from one UE UL transmission port allocation per band in one of the multicarrier switching mappings to another UE UL transmission port allocation per band in another one of the multicarrier switching mappings.

Example 75 includes the subject matter of Example 73, wherein the three or more bands correspond to four bands, and multi-carrier TX switching table includes up to eight multi-carrier TX switching mappings for the UE including two or more of: a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, three options for UE UL transmission port allocation per band including three first allocations corresponding to, respectively, a first option including a single antenna port for the first band, no antenna port for the second band, no antenna port for the third band, and no antenna port for the fourth band (1P+0P+0P+0P), a second option including 1P+1P+0P+0P and a third option including 0P+1P+0P+0P; a second multi-carrier TX switching mapping including, on one hand, a second TX chain configuration corresponding to 1T+0T+1T+0T, and on another hand, three options for UE UL transmission port allocation per band including three second allocations corresponding to, respectively, 1P+0P+0P+0P, 1P+0P+1P+0P and 0P+0P+1P+0P; a third multi-carrier TX switching mapping including, on one hand, a third TX chain configuration corresponding to 1T+0T+0T+1T, and on another hand, three options for UE UL transmission port allocation per band including three third allocations corresponding to, respectively, 1P+0P+0P+0P, 1P+0P+0P+1P and 0P+0P+0P+1P; a fourth multi-carrier TX switching mapping including, on one hand, a fourth TX chain configuration corresponding to 0T+1T+1T+0T, and on another hand, three options for UE UL transmission port allocation per band including three fourth allocations corresponding to, respectively, 0P+1P+0P+0P, 0P+1P+1P+0P and 0P+0P+1P+0P; a fifth multi-carrier TX switching mapping including, on one hand, a fifth TX chain configuration corresponding to 0T+1T+0T+1T, and on another hand, three options for UE UL transmission port allocation per band including three fifth allocations corresponding to, respectively, 0P+1P+0P+0P, 0P+1P+0P+1P and 0P+0P+0P+1P; a sixth multi-carrier TX switching mapping including, on one hand, a sixth TX chain configuration corresponding to 0T+0T+1T+1T, and on another hand, three options for UE UL transmission port allocation per band including three sixth allocations corresponding to, respectively, 0P+0P+1P+0P, 0P+0P+1P+1P and 0P+0P+0P+1P; a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P; a eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P; a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P, wherein TX switching includes switching from one UE UL transmission port allocation per band in one of the multicarrier switching mappings to another UE UL transmission port allocation per band in another one of the multicarrier switching mappings.

Example 76 includes the subject matter of Example 73, the operations further including identifying a delay for the TX switching (TX switching delay) at least one of: in response to a determination that a current TX chain configuration of the UE corresponds to a single TX chain (1T) on a first carrier in a first band of the three or more bands, and 1T on a second carrier in a second band of the three or more bands, in which case the message is to configure the UE to switch a next UL transmission to a 2 antenna port transmission on either the first carrier in the first band or the second carrier in the second band; in response to a determination that a current TX chain configuration of the UE corresponds to 1T on a first carrier in the first band and 1T on a second carrier in the second band, in which case the message is to configure the UE to switch a next UL transmission to a 2 antenna port transmission on a third carrier in a third band of the three or more bands; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the first carrier in the first band and 1-port transmission on the third carrier in the third band; in response to a determination that a current TX chain configuration of the UE corresponds to 1T on the first carrier in the first band and 1T on the second carrier in the second band, in which case the message is to configure the UE to switch a next UL transmission to a 1 antenna port transmission on the second carrier in the second band and 1-port transmission on the third carrier in the third band; in response to a determination that a current TX chain configuration of the UE corresponds to 1T on the first carrier in the first band and 1T on the second carrier in the second band, the next UL transmission has 1-port transmission on the third carrier in a third band; in response to a determination that a current TX chain configuration of the UE corresponds to 0Tx on the first carrier in the first band and 2Tx on the second carrier in the second band, in which case the message is to configure the UE to switch a next UL transmission to a 1 antenna port transmission or to a 2 antenna port transmission on the first carrier in the first band; or in response to a determination that a current TX chain configuration of the UE corresponds to 2Tx on the first carrier in the first band and 0Tx on the second carrier in the second band, in which case the message is to configure the UE to switch a next UL transmission to a 1 antenna port transmission or to a 2 antenna port transmission on the second carrier in the second band.

Example 77 include a machine-readable medium including code which, when executed, is to cause a machine to perform the method of any one of claims 27-38 and 53-64.

Example 78 include an apparatus including means to perform the method of any one of claims 27-38 and 53-64.

Example A1 is a method to be performed at UE, the method including identifying more than two frequency bands for transmit (Tx) switching, and providing an indication of the more than two frequency bands to a UE for use in Tx switching.

Example A2 includes a method to be performed at a gNB, the method including identifying more than two frequency bands for transmit (Tx) switching, and performing, based on the identified frequency bands, Tx switching.

Example B1 may include the system and method of wireless communication for a fifth generation (5G) or new radio (NR) system: configuring, by gNB, more than two bands for transmit (Tx) switching; performing, by UE, Tx switching based on the configured more than 2 bands; Example B2 may include the method of Example B1, and/or some other Example, wherein the mapping between UL transmission ports and Tx chain for multi-carrier Tx switching is defined in accordance with the band and/or carrier index, which is activated and configured for Tx switching.

Example B3 may include the method of Example B1, and/or some other Example herein, wherein for carrier aggregation (CA) option 1, where if uplink Tx switching is configured, UE is not expected to be scheduled or configured with UL transmission on both bands (carriers), when UE performs Tx switching across 3 bands, i.e., Band A, B and C, respectively, the mapping between UL transmission ports and Tx chain for CA option 1 across 3 bands can be defined in Table 2, Table 3, Table 4 or Table 5.

Example B4 may include the method of Example B1, and/or some other Example herein, wherein for CA option 2, where if uplink Tx switching is configured, UE can be scheduled or configured with UL transmission on both bands (carriers) simultaneously, when UE performs Tx switching across 3 bands, i.e., Band A, B and C, respectively, the mapping between UL transmission ports and Tx chain across 3 bands can be defined in Table 6, Table 7 or Table 8.

Example B5 may include the method of Example B1, and/or some other Example herein, wherein for CA option 1, where if uplink Tx switching is configured, UE is not expected to be scheduled or configured with UL transmission on both bands (carriers), when UE performs Tx switching across 4 bands, i.e., Band A, B, C and D, respectively, the mapping between UL transmission ports and Tx chain for CA option 1 across 4 bands can be defined in Table 9, Table 10 or Table 11.

Example B6 may include the method of Example B1, and/or some other Example herein, wherein for CA option 2, where if uplink Tx switching is configured, UE can be scheduled or configured with UL transmission on both bands (carriers) simultaneously, when UE performs Tx switching across 4 bands, i.e., Band A, B, C and D, respectively, the mapping between UL transmission ports and Tx chain across 4 bands can be defined in Table 12 or 13.

Example B7 may include the method of Example B1, and/or some other Example herein, wherein different uplink CA options are applicable for different pairs of bands.

Example B8 may include the method of Example B7, and/or some other Example herein, wherein for the switching between a band configured with a UL carrier of a cell and another band configured with SUL carrier of the same cell, only uplink CA option 1 is used

Example B9 may include the method of Example B7, and/or some other Example herein, wherein for the switching between a band configured with SUL carrier of a cell and another band, only uplink CA option 1 is used.

Example B10 may include the method of Example B7, and/or some other Example herein, wherein the UL CA option 1 or 2 for Tx switching is separately configured for each pair of bands.

Example B11 may include the method of Example B1, and/or some other Example herein, wherein for uplink CA option 2 of mapping between UL transmission ports and Tx chain, the Tx switching delay is applicable for the following cases: 1) If the current state of Tx chains is 1Tx on a first carrier in a first band and 1Tx on a second carrier in a second band, the next UL transmission has a 2-port transmission on a third carrier in a third band; 2) If the current state of Tx chains is 1Tx on a first carrier in a first band and 1Tx on a second carrier in a second band, the next UL transmission has a 1-port transmission on the first carrier in the first band and 1-port transmission on a third carrier in a third carrier. 3) If the current state of Tx chains is 1Tx on a first carrier in a first band and 1Tx on a second carrier in a second band, the next UL transmission has a 1-port transmission on the second carrier in the second band and 1-port transmission on a third carrier in a third carrier.

Example B12 may include the method of Example B1, and/or some other Example herein, wherein for CA Option 2, if UL Tx switching is triggered for 1-port transmission on a first carrier in a first band and the state of Tx chains after the UL Tx switching is not unique, for example, when the UE is under the operation state in which 2-port transmission can be supported on one carrier on one band followed by no transmission on any carrier on the same band and 1-port transmission on the other carrier on another band, a parameter can be configured by dedicated radio resource control (RRC) signaling or dynamically indicated in the downlink control information (DCI) or a combination thereof to configure or indicate the state of Tx chains and band information.

Example B13 may include the method of Example B1, and/or some other Example herein, wherein the second band is one of bands configured or activated for Tx switching, and the second band can be configured by higher layers or implicitly determined according to a pre-defined rule. For example, the second band is the next band with smallest or largest band index, or the second band is the band used for last transmission, or the band next to the first band (either with a larger index or smaller index).

Example B14 may include the method of Example B1, and/or some other Example herein, wherein additional parameter may be configured by RRC signaling to configure between the following: 1) 1Tx on the first carrier in the first band and 1Tx on a second carrier in a second band is assumed. 2) 1Tx on the first carrier in the first band and 1Tx on a third carrier in a third band is assumed. 3) 1Tx on the first carrier in the first band and 1Tx on a fourth carrier in a fourth band is assumed.

Example B15 may include the method of Example B1, and/or some other Example herein, wherein the switching gap on a carrier is configured with condition. For a carrier in a band, gNB may configure whether switching gap on the carrier is supported and the condition to apply the switching gap.

Example B16 includes a method to be performed by a fifth generation (5G) base station (gNB), one or more elements of a gNB, and/or an electronic device that includes a gNB, wherein the method comprises: identifying more than two frequency bands for transmit (Tx) switching; and providing an indication of the more than two frequency bands to a UE for use in Tx switching.

Example B17 includes a method to be performed by a user equipment (UE), one or more elements of a UE, and/or an electronic device that includes a UE, wherein the method comprises: identifying more than two frequency bands for transmit (Tx) switching; and performing, based on the identified frequency bands, Tx switching.

Example B18 includes the method of Example B17, and/or some other Example herein, wherein the identifying the more than two frequency bands is based on one or more indications received from a fifth generation (5G) base station (gNB).

Example C1 may include an apparatus comprising means to perform one or more elements of a method described in or related to any of the method Examples above, or any other method or process described herein.

Example C2 may include one or more non-transitory computer-readable media comprising instructions to cause an electronic device, upon execution of the instructions by one or more processors of the electronic device, to perform one or more elements of a method described in or related to any of the method Examples above, or any other method or process described herein.

Example C3 may include an apparatus comprising logic, modules, or circuitry to perform one or more elements of a method described in or related to any of the method Examples above, or any other method or process described herein.

Example C4 may include a method, technique, or process as described in or related to any of the method Examples above, or portions or parts thereof.

Example C5 may include an apparatus comprising: one or more processors and one or more computer-readable media comprising instructions that, when executed by the one or more processors, cause the one or more processors to perform the method, techniques, or process as described in or related to any of the method Examples above, or portions thereof.

Example C6 may include a signal as described in or related to any of the method Examples above, or portions or parts thereof.

Example C7 may include a datagram, packet, frame, segment, protocol data unit (PDU), or message as described in or related to any of the method Examples above, or portions or parts thereof, or otherwise described in the present disclosure.

Example C8 may include a signal encoded with data as described in or related to any of the method Examples above, or portions or parts thereof, or otherwise described in the present disclosure.

Example C9 may include a signal encoded with a datagram, packet, frame, segment, protocol data unit (PDU), or message as described in or related to any of the method Examples above, or portions or parts thereof, or otherwise described in the present disclosure.

Example C10 may include an electromagnetic signal carrying computer-readable instructions, wherein execution of the computer-readable instructions by one or more processors is to cause the one or more processors to perform the method, techniques, or process as described in or related to any of the method Examples above, or portions thereof.

Example C11 may include a computer program comprising instructions, wherein execution of the program by a processing element is to cause the processing element to carry out the method, techniques, or process as described in or related to any of the method Examples above, or portions thereof.

Example C12 may include a signal in a wireless network as shown and described herein.

Example C13 may include a method of communicating in a wireless network as shown and described herein.

Example C14 may include a system for providing wireless communication as shown and described herein.

Example C15 may include a device for providing wireless communication as shown and described herein.

Example Z01 may include an apparatus comprising means to perform one or more elements of a method described in or related to any of Examples related to a method herein, or any other method or process described herein.

Example Z02 may include one or more non-transitory computer-readable media comprising instructions to cause an electronic device, upon execution of the instructions by one or more processors of the electronic device, to perform one or more elements of a method described in or related to any of Examples related to a method herein, or any other method or process described herein.

Example Z03 may include an apparatus comprising logic, modules, or circuitry to perform one or more elements of a method described in or related to any of Examples related to a method herein, or any other method or process described herein.

Example Z04 may include a method, technique, or process as described in or related to any of Examples related to methods herein, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of Examples related to methods herein, or portions thereof.

Example Z06 may include a signal as described in or related to any of Examples related to methods herein, or portions or parts thereof.

Example Z07 may include a datagram, packet, frame, segment, protocol data unit (PDU), or message as described in or related to any of Examples related to methods herein, or portions or parts thereof, or otherwise described in the present disclosure.

Example Z08 may include a signal encoded with data as described in or related to any of Examples related to methods herein, or portions or parts thereof, or otherwise described in the present disclosure.

Example Z09 may include a signal encoded with a datagram, packet, frame, segment, protocol data unit (PDU), or message as described in or related to any of Examples related to methods herein, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of Examples related to methods herein, or portions thereof.

Example Z11 may include a computer program comprising instructions, wherein execution of the program by a processing element is to cause the processing element to carry out the method, techniques, or process as described in or related to any of Examples related to methods herein, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

1-25. (canceled)

26. An apparatus of a New Radio (NR) Node B (gNB) including:
one or more processors to perform operations including:
identifying three or more bands for transmit (TX) switching by a user equipment (UE); and
encoding for transmission a message to the UE to indicate the three or more bands for TX switching; and
a memory to store the three or more bands for TX switching.

27. The apparatus of claim 26, wherein:
identifying includes accessing a multi-carrier TX switching table that includes a plurality of multi-carrier TX switching mappings for the UE, individual ones of the plurality of multi-carrier TX switching mappings including, on one hand, a TX chain configuration of the UE, and one another hand, one or more options for UE uplink (UL) transmission port allocation per band;
the TX chain configuration of the UE corresponds to an indication of a number of TX chains configured at the UE per band of the three or more bands; and
an individual one of the one or more options for UE UL transmission port allocation per band includes an allocation of one or more antenna ports for UL transmission per band.

28. The apparatus of claim 27, wherein a number of the plurality of multi-carrier TX switching mappings for the UE is based on a number of the three or more bands.

29. The apparatus of claim 28, wherein the number of the plurality of multi-carrier TX switching mappings for the UE is further based on the TX chain configuration of the UE.

30. The apparatus of claim 27, the operations further including, prior to accessing the multi-carrier TX switching table, determining the multi-carrier TX switching table from a plurality of multi-carrier TX switching tables based on a number of the three or more bands.

31. The apparatus of claim 30, wherein determining the multi-carrier TX switching table is further based on a determination that the UE is configured for carrier aggregation and not expected to be scheduled or configured with simultaneous UL transmissions on more than one band of the three or more bands.

32. The apparatus of claim 31, wherein the three or more bands correspond to three bands, and multi-carrier TX switching table includes up to six multi-carrier TX switching mappings for carrier aggregation option with switching UL for the UE including two or more of:
a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, a single option for UE UL transmission port allocation per band including a first allocation corresponding to a single antenna port for the first band, no antenna port for the second band, and no antenna port for the third band (1P+0P+0P);
a second multi-carrier TX switching mapping including, on one hand, a second TX chain configuration corresponding to 1T+0T+1T, and on another hand, a single option for UE UL transmission port allocation per band including a second allocation corresponding to 1P+0P+0P;
a third multi-carrier TX switching mapping including, on one hand, a third TX chain configuration corresponding to 0T+1T+1T, and on another hand, a single option for UE UL transmission port allocation per band including a third allocation corresponding to 0P+1P+0P;
a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P;
a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or
a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P,
wherein TX switching includes switching from one UE UL transmission port allocation per band in one of the plurality of multi-carrier TX switching mappings to another UE UL transmission port allocation per band in another one of the plurality of multi-carrier TX switching mappings.

33. The apparatus of claim 31, wherein the three or more bands correspond to four bands, and multi-carrier TX switching table includes up to ten multi-carrier TX switching mappings for carrier aggregation option with switching UL for the UE including two or more of:
a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, a single option for UE UL transmission port allocation per band including an allocation corresponding to a single antenna port for the first band, no antenna port for the second band, no antenna port for the third band, and no antenna port for the fourth band (1P+0P+0P+0P);
a second multi-carrier TX switching mapping including, on one hand, a second TX chain configuration corresponding to 1T+0T+1T+0T, and on another hand, a single option for UE UL transmission port allocation per band including a second allocation corresponding to 1P+0P+0P+0P;
a third multi-carrier TX switching mapping including, on one hand, a third TX chain configuration corresponding to 1T+0T+0T+1T, and on another hand, a single options for UE UL transmission port allocation per band including a third allocation corresponding to 1P+0P+0P+0P;
a fourth multi-carrier TX switching mapping including, on one hand, a fourth TX chain configuration corresponding to 0T+1T+1T+0T, and on another hand, a single option for UE UL transmission port allocation per band including a fourth allocation corresponding to 0P+1P+0P+0P;
a fifth multi-carrier TX switching mapping including, on one hand, a fifth TX chain configuration corresponding to 0T+1T+0T+1T, and on another hand, a single option for UE UL transmission port allocation per band including a fifth allocations corresponding to 0P+1P+0P+0P;
a sixth multi-carrier TX switching mapping including, on one hand, a sixth TX chain configuration corresponding to 0T+0T+1T+1T, and on another hand, a single option for UE UL transmission port allocation per band including a sixth allocation corresponding to 0P+0P+1P+0P;
a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P;
an eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P;
a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or
a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P,
wherein TX switching includes switching from one UE UL transmission port allocation per band in one of the plurality of multi-carrier TX switching mappings to another UE UL transmission port allocation per band in another one of the plurality of multi-carrier TX switching mappings.

34. The apparatus of claim 30, wherein determining the multi-carrier TX switching table is further based on a determination that the UE is configured for carrier aggregation and expected to be scheduled or configured with simultaneous UL transmissions on more than one band of the three or more bands.

35. The apparatus of claim 34, wherein the three or more bands correspond to three bands, and multi-carrier TX switching table includes up to six multi-carrier TX switching mappings for carrier aggregation option with dual UL for the UE including two or more of:
a first multi-carrier TX switching mapping including, on one hand, a first TX chain configuration corresponding to a single TX chain for a first band of the three bands, a single TX chain for a second band of the three bands, and no TX chain for a third band of the three bands (1T+1T+0T), and on another hand, three options for UE UL transmission port allocation per band including three first allocations corresponding to, respectively, a first option including a single antenna port for the first band, no antenna port for the second band, and no antenna port for the third band (1P+0P+0P), a second option including 1P+1P+0P and a third option including 0P+1P+0P;
a second multi-carrier TX switching mapping including, on one hand, a second TX chain configuration corresponding to 1T+0T+1T, and on another hand, three options for UE UL transmission port allocation per band including three second allocations corresponding to, respectively, 1P+0P+0P, 1P+0P+1P and 0P+0P+1P;
a third multi-carrier TX switching mapping including, on one hand, a third TX chain configuration corresponding to 0T+1T+1T, and on another hand, three options for UE UL transmission port allocation per band including three third allocations corresponding to, respectively, 0P+1P+0P, 0P+1P+1P and 0P+0P+1P;
a fourth multi-carrier TX switching mapping including, on one hand, a fourth TX chain configuration corresponding to 0T+2T+0T, and on another hand, two options for UE UL transmission port allocation per band including two fourth allocations corresponding to, respectively, 0P+2P+0P and 0P+1P+0P;
a fifth multi-carrier TX switching mapping including, on one hand, a fifth TX chain configuration corresponding to 0T+0T+2T, and on another hand, two options for UE UL transmission port allocation per band including two fifth allocations corresponding to, respectively, 0P+0P+2P and 0P+0P+1P; or
a sixth multi-carrier TX switching mapping including, on one hand, a sixth TX chain configuration corresponding to 2T+0T+0T, and on another hand, two options for UE UL transmission port allocation per band including two sixth allocations corresponding to, respectively, 2P+0P+0P and 1P+0P+0P,
wherein TX switching includes switching from one UE UL transmission port allocation per band in one of the plurality of multi-carrier TX switching mappings to another UE UL transmission port allocation per band in another one of the plurality of multi-carrier TX switching mappings.

36. The apparatus of claim 34, wherein the three or more bands correspond to four bands, and multi-carrier TX switching table includes up to eight multi-carrier TX switching mappings for carrier aggregation option with dual UL for the UE including two or more of:
a first multi-carrier TX switching mapping including, on one hand, a first TX chain configuration corresponding to a single TX chain for a first band of the four bands, a single TX chain for a second band of the four bands, no TX chain for a third band of the four bands, and no TX chain for a fourth band of the four bands (1T+1T+0T+0T), and on another hand, three options for UE UL transmission port allocation per band including three first allocations corresponding to, respectively, a first option including a single antenna port for the first band, no antenna port for the second band, no antenna port for the third band, and no antenna port for the fourth band (1P+0P+0P+0P), a second option including 1P+1P+0P+0P and a third option including 0P+1P+0P+0P;
a second multi-carrier TX switching mapping including, on one hand, a second TX chain configuration corresponding to 1T+0T+1T+0T, and on another hand, three options for UE UL transmission port allocation per band including three second allocations corresponding to, respectively, 1P+0P+0P+0P, 1P+0P+1P+0P and 0P+0P+1P+0P;
a third multi-carrier TX switching mapping including, on one hand, a third TX chain configuration corresponding to 1T+0T+0T+1T, and on another hand, three options for UE UL transmission port allocation per band including three third allocations corresponding to, respectively, 1P+0P+0P+0P, 1P+0P+0P+1P and 0P+0P+0P+1P;
a fourth multi-carrier TX switching mapping including, on one hand, a fourth TX chain configuration corresponding to 0T+1T+1T+0T, and on another hand, three options for UE UL transmission port allocation per band including three fourth allocations corresponding to, respectively, 0P+1P+0P+0P, 0P+1P+1P+0P and 0P+0P+1P+0P;
a fifth multi-carrier TX switching mapping including, on one hand, a fifth TX chain configuration corresponding to 0T+1T+0T+1T, and on another hand, three options for UE UL transmission port allocation per band including three fifth allocations corresponding to, respectively, 0P+1P+0P+0P, 0P+1P+0P+1P and 0P+0P+0P+1P;
a sixth multi-carrier TX switching mapping including, on one hand, a sixth TX chain configuration corresponding to 0T+0T+1T+1T, and on another hand, three options for UE UL transmission port allocation per band including three sixth allocations corresponding to, respectively, 0P+0P+1P+0P, 0P+0P+1P+1P and 0P+0P+0P+1P;
a seventh multi-carrier TX switching mapping including, on one hand, a seventh TX chain configuration corresponding to 0T+0T+0T+2T, and on another hand, two options for UE UL transmission port allocation per band including two seventh allocations corresponding to, respectively, 0P+0P+0P+2P and 0P+0P+0P+1P;
an eighth multi-carrier TX switching mapping including, on one hand, an eighth TX chain configuration corresponding to 0T+0T+2T+0T, and on another hand, two options for UE UL transmission port allocation per band including two eighth allocations corresponding to, respectively, 0P+0P+2P+0P and 0P+0P+1P+0P;
a ninth multi-carrier TX switching mapping including, on one hand, a ninth TX chain configuration corresponding to 0T+2T+0T+0T, and on another hand, two options for UE UL transmission port allocation per band including two ninth allocations corresponding to, respectively, 0P+2P+0P+0P and 0P+1P+0P+0P; or
a tenth multi-carrier TX switching mapping including, on one hand, a tenth TX chain configuration corresponding to 2T+0T+0T+0T, and on another hand, two options for UE UL transmission port allocation per band including two tenth allocations corresponding to, respectively, 2P+0P+0P+0P and 1P+0P+0P+0P,
wherein TX switching includes switching from one UE UL transmission port allocation per band in one of the plurality of multi-carrier TX switching mappings to another UE UL transmission port allocation per band in another one of the plurality of multi-carrier TX switching mappings.

37. The apparatus of claim 34, the operations further including identifying a delay for the TX switching (TX switching delay) at least one of:
in response to a determination that a current TX chain configuration of the UE corresponds to a single TX chain (1T) on a first carrier in a first band of the three or more bands, and 1T on a second carrier in a second band of the three or more bands, in which case the message is to configure the UE to switch a next UL transmission to a 2 antenna port transmission on either the first carrier in the first band or the second carrier in the second band;
in response to a determination that a current TX chain configuration of the UE corresponds to 1T on a first carrier in the first band and 1T on a second carrier in the second band, in which case the message is to configure the UE to switch a next UL transmission to a 2 antenna port transmission on a third carrier in a third band of the three or more bands;
in response to a determination that a current TX chain configuration of the UE corresponds to 1T on the first carrier in the first band and 1T on the second carrier in the second band, in which case the message is to configure the UE to switch a next UL transmission to a 1 antenna port transmission on the first carrier in the first band and 1-port transmission on the third carrier in the third band;
in response to a determination that a current TX chain configuration of the UE corresponds to 1T on the first carrier in the first band and 1T on the second carrier in the second band, in which case the message is to configure the UE to switch a next UL transmission to a 1 antenna port transmission on the second carrier in the second band and 1-port transmission on the third carrier in the third band;
in response to a determination that a current TX chain configuration of the UE corresponds to 1T on the first carrier in the first band and 1T on the second carrier in the second band, the next UL transmission has 1-port transmission on the third carrier in a third band;
in response to a determination that a current TX chain configuration of the UE corresponds to 0Tx on the first carrier in the first band and 2Tx on the second carrier in the second band, in which case the message is to configure the UE to switch a next UL transmission to a 1 antenna port transmission or to a 2 antenna port transmission on the first carrier in the first band; or
in response to a determination that a current TX chain configuration of the UE corresponds to 2Tx on the first carrier in the first band and 0Tx on the second carrier in the second band, in which case the message is to configure the UE to switch a next UL transmission to a 1 antenna port transmission or to a 2 antenna port transmission on the second carrier in the second band.

38. The apparatus of claim 26, further including a Radio Frequency (RF) interface coupled to the one or more processors, and a front end module coupled to the RF interface.

39. The apparatus of claim 38, further including one or more antennas coupled to the front end module to transmit the message.

40. One or more tangible non-transitory machine-readable storage medium comprising instructions to cause one or more processors of a New Radio (NR) Node B (gNB), upon execution of the instructions, to perform operations including:
decoding a message from a NR Node B (gNB), the message indicating three or more bands for transmit (TX) switching;
identifying from the message the three or more bands for TX switching; and
performing TX switching based on the three or more bands for TX switching.

41. The one or more tangible non-transitory machine-readable storage medium of claim 40, wherein the operations further include:
identifying includes accessing a multi-carrier TX switching table that includes a plurality of multi-carrier TX switching mappings for a UE, individual ones of the plurality of multi-carrier TX switching mappings including, on one hand, a TX chain configuration of the UE, and one another hand, one or more options for UE uplink (UL) transmission port allocation per band;
the TX chain configuration of the UE corresponds to an indication of a number of TX chains configured at the UE per band of the three or more bands; and
an individual one of the one or more options for UE UL transmission port allocation per band includes an allocation of one or more antenna ports for UL transmission per band.

42. The one or more tangible non-transitory machine-readable storage medium of claim 41, wherein a number of the plurality of multi-carrier TX switching mappings for the UE is based on a number of the three or more bands.

43. The one or more tangible non-transitory machine-readable storage medium of claim 42, wherein the number of the plurality of multi-carrier TX switching mappings for the UE is further based on the TX chain configuration of the UE.

44. An apparatus a New Radio (NR) Node B (gNB) including:
means for decoding a message from a NR Node B (gNB), the message indicating three or more bands for transmit (TX) switching;
means for identifying from the message the three or more bands for TX switching; and
means for performing TX switching based on the three or more bands for TX switching.

45. The apparatus of claim 44, further including means for identifying includes accessing a multi-carrier TX switching table that includes a plurality of multi-carrier TX switching mappings for a UE, individual ones of the plurality of multi-carrier TX switching mappings including, on one hand, a TX chain configuration of the UE, and one another hand, one or more options for UE uplink (UL) transmission port allocation per band, wherein the TX chain configuration of the UE corresponds to an indication of a number of TX chains configured at the UE per band of the three or more bands, and wherein an individual one of the one or more options for UE UL transmission port allocation per band includes an allocation of one or more antenna ports for UL transmission per band.
